(19) United States
(12) Patent Application Publication
(10) Pub. No.: US 2025/0267658 A1
(43) Pub. Date: Aug. 21, 2025

(54) UPLINK CARRIER AGGREGATION USING MULTI-CELL DOWNLINK CARRIER SHARING

(71) Applicant: QUALCOMM Incorporated, San Diego, CA (US)

(72) Inventors: Javier RODRIGUEZ FERNANDEZ, San Diego, CA (US); Kazuki TAKEDA, Minato-ku (JP)

(21) Appl. No.: 18/583,494

(22) Filed: Feb. 21, 2024

(51) Int. Cl. H04W 72/1273; H04L 1/00; H04W 72/0457; H04W 72/21; H04W 72/232

(52) U.S. Cl. CPC H04W 72/1273; H04L 1/0068; H04W 72/0457; H04W 72/21; H04W 72/232

(57) ABSTRACT

Various aspects of the present disclosure generally relate to wireless communication. In some aspects, a user equipment (UE) may receive a physical downlink (DL) control channel (PDCCH) transmission based at least in part on an uplink (UL) carrier aggregation that uses two or more DL-UL cells that share a same DL carrier, wherein the two or more DL-UL cells are based at least in part on a control channel element (CCE) index mapping. The UE may transmit, based at least in part on a scheduling and the UL-CA, an UL transmission via one of the two or more DL-UL cells. Numerous other aspects are described.

### FIELD OF THE DISCLOSURE

Aspects of the present disclosure generally relate to wireless communication and specifically relate to techniques, apparatuses, and methods for uplink (UL) carrier aggregation (CA) (UL-CA) using multi-cell downlink (DL) carrier sharing.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some implementations, an apparatus for wireless communication includes one or more memories; and one or more processors coupled to the one or more memories, the one or more processors individually or collectively configured to: receive a physical downlink (DL) control channel (PDCCH) transmission based at least in part on an uplink (UL) carrier aggregation (CA) (UL-CA) that uses two or more DL-UL cells that share a same DL carrier, wherein the two or more DL-UL cells are based at least in part on a control channel element (CCE) index mapping; and transmit, based at least in part on a scheduling and the UL-CA, an UL transmission via one of the two or more DL-UL cells.

In some implementations, an apparatus for wireless communication includes one or more memories; and one or more processors coupled to the one or more memories, the one or more processors individually or collectively configured to: transmit a PDCCH transmission based at least in part on an UL-CA that uses two or more DL-UL cells that share a same DL carrier, wherein the two or more DL-UL cells are based at least in part on a CCE index mapping; and receive, based at least in part on a scheduling and the UL-CA, an UL transmission via one of the two or more DL-UL cells.

In some implementations, a method of wireless communication performed by a UE includes receiving a PDCCH transmission based at least in part on an UL-CA that uses two or more DL-UL cells that share a same DL carrier, wherein the two or more DL-UL cells are based at least in part on a CCE index mapping; and transmitting, based at least in part on a scheduling and the UL-CA, an UL transmission via one of the two or more DL-UL cells.

In some implementations, a method of wireless communication performed by a network node includes transmitting a PDCCH transmission based at least in part on an UL-CA that uses two or more DL-UL cells that share a same DL carrier, wherein the two or more DL-UL cells are based at least in part on a CCE index mapping; and receiving, based at least in part on a scheduling and the UL-CA, an UL transmission via one of the two or more DL-UL cells.

In some implementations, a non-transitory computer-readable medium storing a set of instructions for wireless communication includes one or more instructions that, when executed by one or more processors of a UE, cause the UE to: receive a PDCCH transmission based at least in part on an UL-CA that uses two or more DL-UL cells that share a same DL carrier, wherein the two or more DL-UL cells are based at least in part on a CCE index mapping; and transmit, based at least in part on a scheduling and the UL-CA, an UL transmission via one of the two or more DL-UL cells.

In some implementations, a non-transitory computer-readable medium storing a set of instructions for wireless communication includes one or more instructions that, when executed by one or more processors of a network node, cause the network node to: transmit a PDCCH transmission based at least in part on an UL-CA that uses two or more DL-UL cells that share a same DL carrier, wherein the two or more DL-UL cells are based at least in part on a CCE index mapping; and receive, based at least in part on a scheduling and the UL-CA, an UL transmission via one of the two or more DL-UL cells.

In some implementations, an apparatus for wireless communication includes means for receiving a PDCCH transmission based at least in part on an UL-CA that uses two or more DL-UL cells that share a same DL carrier, wherein the two or more DL-UL cells are based at least in part on a CCE index mapping; and means for transmitting, based at least in part on a scheduling and the UL-CA, an UL transmission via one of the two or more DL-UL cells.

In some implementations, an apparatus for wireless communication includes means for transmitting a PDCCH transmission based at least in part on an UL-CA that uses two or more DL-UL cells that share a same DL carrier, wherein the two or more DL-UL cells are based at least in part on a CCE index mapping; and means for receiving, based at least in part on a scheduling and the UL-CA, an UL transmission via one of the two or more DL-UL cells.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of cells that support enhanced uplink (UL) carrier aggregation (CA) (UL-CA), in accordance with the present disclosure.

FIG. 5 is a diagram illustrating an example associated with UL-CA using multi-cell downlink (DL) carrier sharing, in accordance with the present disclosure.

FIG. 6 is a diagram illustrating an example associated with fully overlapping DL carriers, in accordance with the present disclosure.

FIG. 7 is a diagram illustrating an example associated with a scheduling of fully-overlapped carriers, in accordance with the present disclosure.

FIG. 8 is a diagram illustrating an example associated with puncturing, in accordance with the present disclosure.

FIG. 9 is a diagram illustrating an example associated with contiguous control channel element (CCE) indexes mapping to cells, in accordance with the present disclosure.

FIG. 10 is a diagram illustrating an example associated with assigning CCE indexes to cells in a dynamic manner, in accordance with the present disclosure.

FIG. 11 is a diagram illustrating an example associated with a non-uniform mapping, in accordance with the present disclosure.

FIG. 12 is a diagram illustrating an example associated with a CCE-to-physical downlink control channel (PDCCH) hashing function, in accordance with the present disclosure.

FIG. 13 is a diagram illustrating an example associated with a CCE-to-PDCCH mapping, in accordance with the present disclosure.

FIG. 14 is a diagram illustrating an example associated with a CCE-to-PDCCH mapping, in accordance with the present disclosure.

FIG. 15 is a diagram illustrating an example associated with a priority ordering, in accordance with the present disclosure.

FIGS. 16-17 are diagrams illustrating example processes associated with UL-CA using multi-cell DL carrier sharing, in accordance with the present disclosure.

FIGS. 18-19 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Uplink (UL) carrier aggregation (CA) (UL-CA) and supplementary uplink (SUL) use cases may be unified through enhanced SUL (eSUL), which may be referred to as eUL-CA. Cells that service eSUL use cases may be perceived as UL-only by some user equipment (UEs), while other cells may be downlink (DL) and UL. The cells that serve eSUL use cases may require a definition of UL-only cells in radio resource control (RRC) signaling with no DL bandwidth part (BWP) (DL-BWP). In future wireless systems (e.g., sixth generation (6G) and beyond), eSUL cases may be served with UL-only cells or fully overlapping downlink and uplink cells.

Cells that serve eSUL use cases may be perceived as UL-only by some UEs, which may require a definition of UL-only cells in RRC signaling with no DL-BWP. Cells that are considered to be UL-only may not be useable for downlink transmissions. Such cells may be useful for enhanced UL-CA and SUL, but may not be useable for downlink transmissions. A UE may not be configured with other alternatives, such that eSUL use cases may not be possible when the UE is unable to receive RRC signaling that defines the UL-only cells.

Various aspects relate generally to UL-CA. Some aspects more specifically relate to UL-CA using multi-cell DL carrier sharing. In some examples, a UE may receive, from a network node, a serving cell configuration information element (IE) that includes a configuration for two or more DL-UL cells and UL control information. The two or more DL-UL cells may share a same DL carrier. The UE may receive, from the network node, a physical downlink control channel (PDCCH) transmission based at least in part on an UL-CA that uses the two or more DL-UL cells that share the same DL carrier. The two or more DL-UL cells may be based at least in part on a control channel element (CCE) index mapping. PDCCH candidates from different DL-UL cells may be mapped to different CCE indexing patterns in a control resource set (CORESET) for the UE. Non-contiguous CCE indexes may be mapped to the two or more DL-UL cells based at least in part on a CCE indexing pattern. A non-contiguous starting CCE index for a PDCCH may be mapped to the two or more DL-UL cells based at least in part on the CCE indexing pattern. A non-contiguous starting CCE index and an ending CCE index for a PDCCH may be mapped to the two or more DL-UL cells based at least in part on a CCE indexing pattern. Contiguous CCE indexes may be mapped to the two or more DL-UL cells based at least in part on the CCE indexing pattern. In some aspects, the UE may receive, from the network node, an indication of a scheduled DL-UL cell, of the two or more DL-UL cells, for an UL grant. The UE may transmit, based at least in part on a scheduling and the UL-CA, an UL transmission via one of the two or more DL-UL cells. The UL transmission may be based at least in part on the indication.

Particular aspects of the subject matter described in this disclosure can be implemented to realize one or more of the following potential advantages. In some examples, by enabling the UE to use fully overlapping DL and UL cells, the described techniques can be used to enable eSUL use cases without necessarily limiting the UE to using UL-only cells. The UE may be able to use UL-only cells or use the fully overlapping DL and UL cells, which may refer to DL and UL cells that share the same DL carrier. The UE may be able to receive DL control/data from the same DL carrier shared across cells, and the UE may be scheduled to transmit on any of the available UL carriers. Such an approach may provide UL-CA using multi-cell DL carrier sharing, which may improve both a DL and UL performance of the UE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

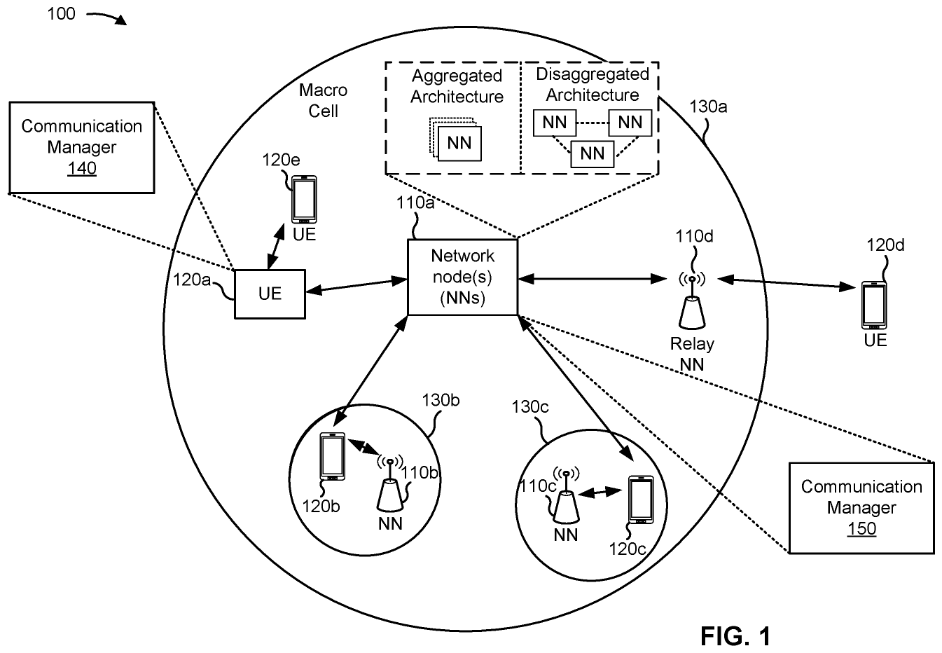

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more PDCCHs, and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into BWPs. A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., the UE 120) may include a communication manager 140. As described in more detail elsewhere herein, the communication manager 140 may receive a PDCCH transmission based at least in part on an UL-CA that uses two or more DL-UL cells that share a same DL carrier, wherein the two or more DL-UL cells are based at least in part on a CCE index mapping; and transmit, based at least in part on a scheduling and the UL-CA, an UL transmission via one of the two or more DL-UL cells. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a PDCCH transmission based at least in part on an UL-CA that uses two or more DL-UL cells that share a same DL carrier, wherein the two or more DL-UL cells are based at least in part on a CCE index mapping; and receive, based at least in part on a scheduling and the UL-CA, an UL transmission via one of the two or more DL-UL cells. Additionally, or alternatively, the communication manager 150 may perform one or more other operations described herein.

As indicated above, FIG. 1 is provided as an example. Other examples may differ from what is described with regard to FIG. 1.

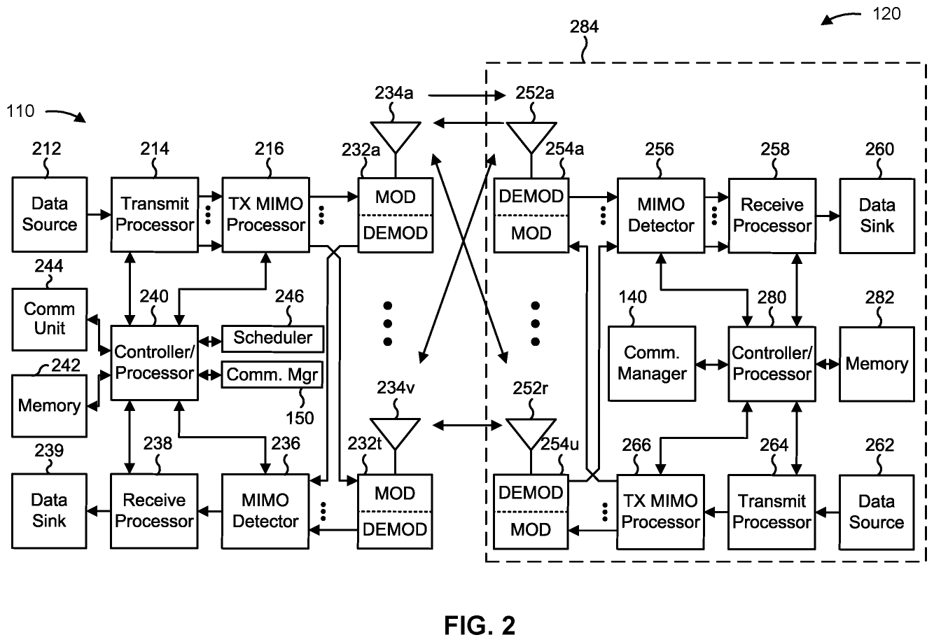

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

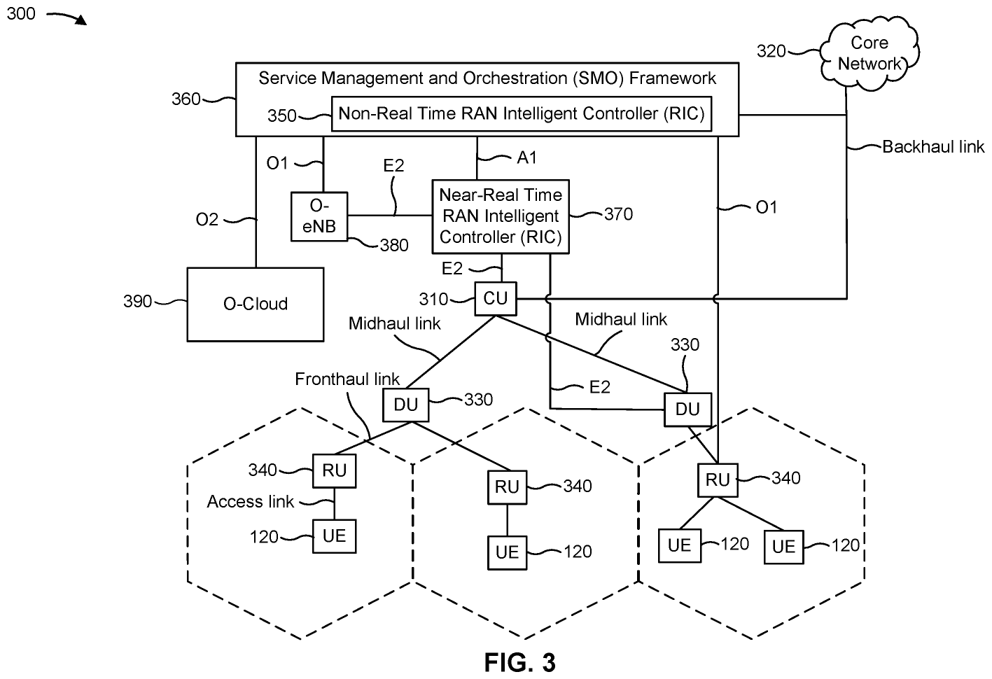

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

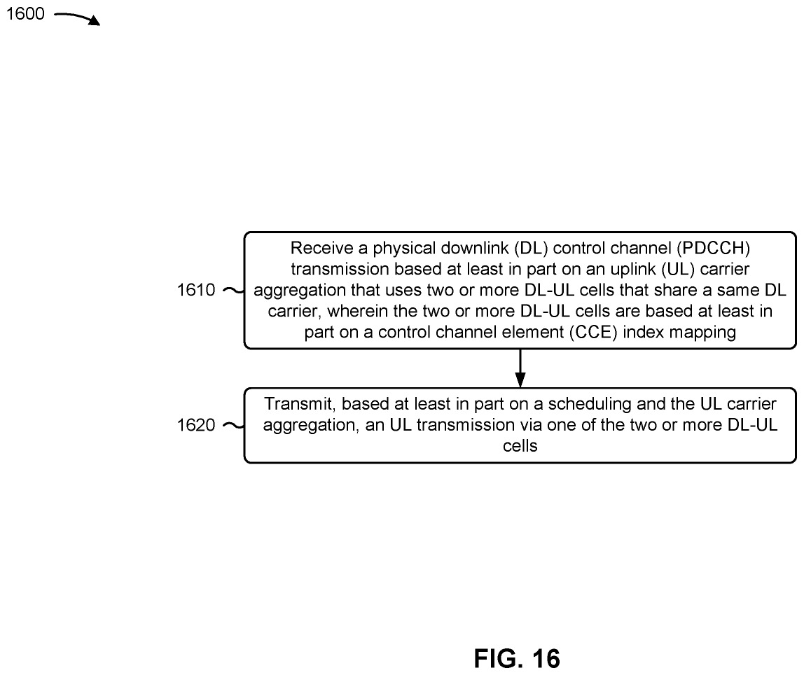

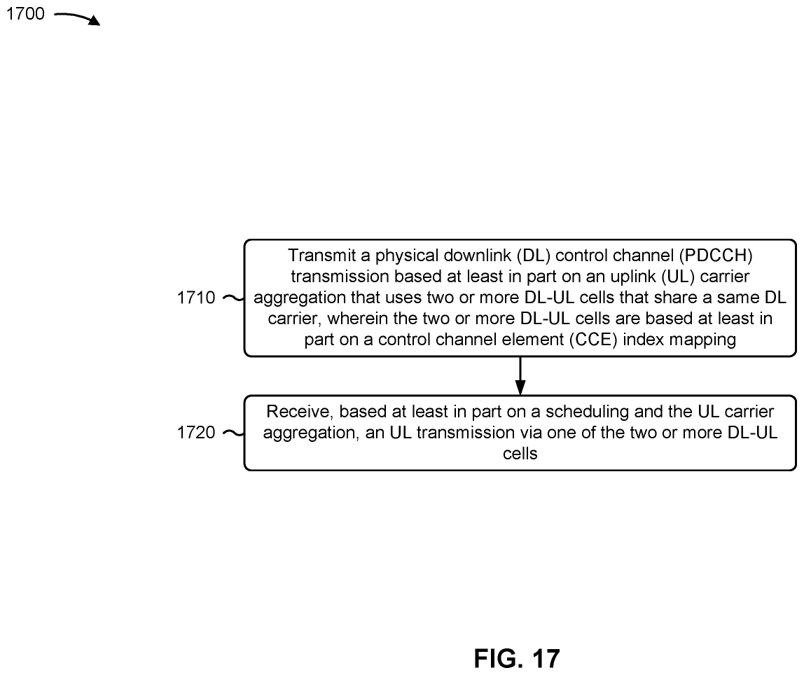

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with UL-CA using multi-cell DL carrier sharing, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1600 of FIG. 16, process 1700 of FIG. 17, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1600 of FIG. 16, process 1700 of FIG. 17, or other processes as described herein. In some examples, executing instructions may include running the instructions, converting the instructions, compiling the instructions, and/or interpreting the instructions, among other examples.

In some aspects, a UE (e.g., the UE 120) includes means for receiving a PDCCH transmission based at least in part on an UL-CA that uses two or more DL-UL cells that share a same DL carrier, wherein the two or more DL-UL cells are based at least in part on a CCE index mapping; and/or means for transmitting, based at least in part on a scheduling and the UL-CA, an UL transmission via one of the two or more DL-UL cells. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a PDCCH transmission based at least in part on an UL-CA that uses two or more DL-UL cells that share a same DL carrier, wherein the two or more DL-UL cells are based at least in part on a CCE index mapping; and/or means for receiving, based at least in part on a scheduling and the UL-CA, an UL transmission via one of the two or more DL-UL cells. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

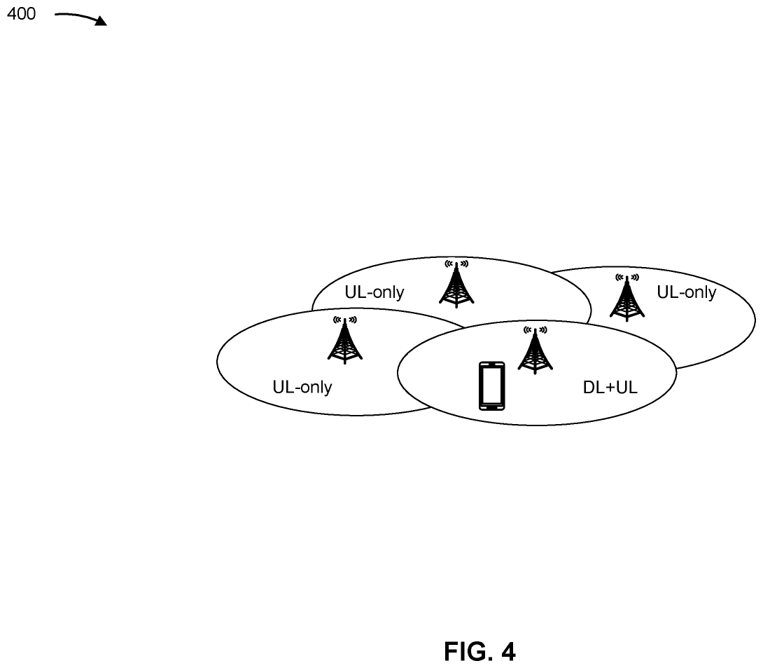

FIG. 4 is a diagram illustrating an example 400 of cells that support enhanced UL-CA (eUL-CA), in accordance with the present disclosure.

As shown in FIG. 4, UL-CA and SUL use cases may be unified through eSUL, which may be referred to as eUL-CA. Cells that service eSUL use cases may be perceived as UL-only by some UEs, while other cells may be DL and UL. The cells that serve eSUL use cases may require a definition of UL-only cells in RRC signaling with no DL-BWP. In future wireless systems (e.g., 6G and beyond), eSUL cases may be served with UL-only cells or fully overlapping downlink and uplink cells.

As indicated above, FIG. 4 is provided as an example. Other examples may differ from what is described with regard to FIG. 4.

An NR system may support SUL. SUL may be an uplink carrier that is associated with a downlink and uplink serving cell. SUL may be configured to improve an UL coverage for high frequency scenarios. With SUL, a UE may be configured with two ULs for one DL of the same cell. SUL may support both an idle mode and a connected mode. In the idle mode, the UE may read a system information block (SIB1) and identify SUL configurations from a supplementary uplink (supplementaryUplink) parameter in a serving cell configuration common SIB (ServingCellConfigCommonSIB) in the SIB1. The ServingCellConfigCommonSIB may include both an uplink configuration common (UplinkConfigCommon) parameter and the supplementaryUplink. To get into the connected mode, the UE may trigger a random access procedure on either an UL carrier or a SUL carrier of the cell.

In the connected mode, the UE may be configured with, or may be indicated to, a transmit UL on either of an UL carrier or a SUL carrier at a time (e.g., not simultaneously on both). A PUCCH transmission may be semi-statically configured on either an UL carrier or SUL carrier. A PUSCH transmission may be semi-statically configured or dynamically indicated on either an UL carrier or SUL carrier. When the UE supports dynamic scheduling of the PUSCH transmission on either the UL or SUL carrier of a serving cell, and when a network node configures PUSCH transmissions on the UL and SUL carriers of the serving cell, a DCI format for PUSCH scheduling may include a one-bit UL/SUL indicator to indicate on which carrier the DCI format schedules the PUSCH transmission. When the network node does not configure PUSCH transmissions on both UL and SUL carriers, the PUSCH transmission may be on the carrier on which the PUCCH transmission is configured. When the network node does not configure PUSCH transmissions on both UL and SUL carriers, and when the network node does not configure PUCCH transmission, the PUSCH transmission may be on the carrier on which the latest PRACH is transmitted.

A PRACH transmission may be semi-statically configured or dynamically indicated or UE-selected on either an UL carrier or SUL carrier. When the PRACH transmission is configured only on an UL carrier or SUL carrier, the PRACH transmission may be on the carrier. When the PRACH transmission is configured on both an UL carrier and SUL carrier, the UE may select the UL carrier or SUL carrier for the PRACH transmission according to an SSB-RSRP. For a PDCCH-ordered PRACH transmission, a DCI format for a PDCCH-ordered PRACH transmission may include a one-bit UL/SUL indicator to indicate on which carrier the DCI format triggers the PRACH transmission.

In a cross-carrier scheduling, a UE may be configured to monitor a PDCCH on a cell for a PUSCH scheduling on another cell. The PDCCH may be for a DCI format 0_1/0_2 that has a carrier indicator field (CIF), where a value of the CIF may indicate the cell where the DCI schedules the PUSCH. A DCI format 0_0 may not support cross-carrier scheduling. On a scheduling cell, the UE may monitor a PDCCH for different scheduled cell separately. A set of CCEs for PDCCH candidates for each scheduled cell may be derived by different parameters (n_CI values). The DCI format sizes for different scheduled cells may be different. CCEs for PDCCH candidates for different scheduled cells may be counted separately. Hybrid automatic repeat request (HARQ) spaces may be separately prepared for different scheduled cells. In multi-carrier scheduling, a DCI format may include a ‘set-CIF field’, where a corresponding value may indicate a set of cells that can be scheduled by DCI. Different set-CIF values may be configured for different sets of cells. Within the set of cells indicated by the set-CIF field, all or a subset of cell(s) may be scheduled by each DCI.

Cells that serve eSUL use cases may be perceived as UL-only by some UEs, which may require a definition of UL-only cells in RRC signaling with no DL-BWP. Cells that are considered to be UL-only may not be useable for downlink transmissions. Such cells may be useful for enhanced UL-CA and SUL, but may not be useable for downlink transmissions. A UE may not be configured with other alternatives, such that eSUL use cases may not be possible when the UE is unable to receive RRC signaling that defines the UL-only cells.

In various aspects of techniques and apparatuses described herein, a UE may receive, from a network node, a serving cell configuration IE that includes a configuration for two or more DL-UL cells and UL control information. The two or more DL-UL cells may share a same DL carrier. The UE may receive, from the network node, a PDCCH transmission based at least in part on an UL-CA that uses the two or more DL-UL cells that share the same DL carrier. The two or more DL-UL cells may be based at least in part on a CCE index mapping. PDCCH candidates from different DL-UL cells may be mapped to different CCE indexing patterns in a CORESET for the UE. Non-contiguous CCE indexes may be mapped to the two or more DL-UL cells based at least in part on a CCE indexing pattern. A non-contiguous starting CCE index for a PDCCH may be mapped to the two or more DL-UL cells based at least in part on the CCE indexing pattern. A non-contiguous starting CCE index and an ending CCE index for a PDCCH may be mapped to the two or more DL-UL cells based at least in part on a CCE indexing pattern. Contiguous CCE indexes may be mapped to the two or more DL-UL cells based at least in part on the CCE indexing pattern. In some aspects, the UE may receive, from the network node, an indication of a scheduled DL-UL cell, of the two or more DL-UL cells, for an UL grant. The UE may transmit, based at least in part on a scheduling and the UL-CA, an UL transmission via one of the two or more DL-UL cells. The UL transmission may be based at least in part on the indication.

In some aspects, in an enhanced CA for UL-CA using multi-cell DL-carrier sharing, a PDCCH monitoring in UL-CA may be enabled using different cells that share the same DL carrier. A differentiation may be via a DCI payload/payload size, or the differentiation may be via a CCE index mapping to cells, with implications on a CCE to PDCCH hashing function. CCEs/CCE indexes may be mapped to multiple cells sharing a DL frequency to avoid blockage, where the mapping may be blockage-free or blockage-sensitive. Puncturing may be used to reduce inter-user blockage when allocating PDCCH candidates for different cells and users that share the same DL carrier.

In some aspects, by enabling the UE to use fully overlapping DL and UL cells, eSUL use cases may be enabled without necessarily limiting the UE to using UL-only cells. The UE may be able to use UL-only cells or use the fully overlapping DL and UL cells, which may refer to DL and UL cells that share the same DL carrier. The UE may be able to receive DL control/data from the same DL carrier shared across cells, and the UE may be scheduled to transmit on any of the available UL carriers. Such an approach by provide UL-CA using multi-cell DL carrier sharing, which may improve both a DL and UL performance of the UE.

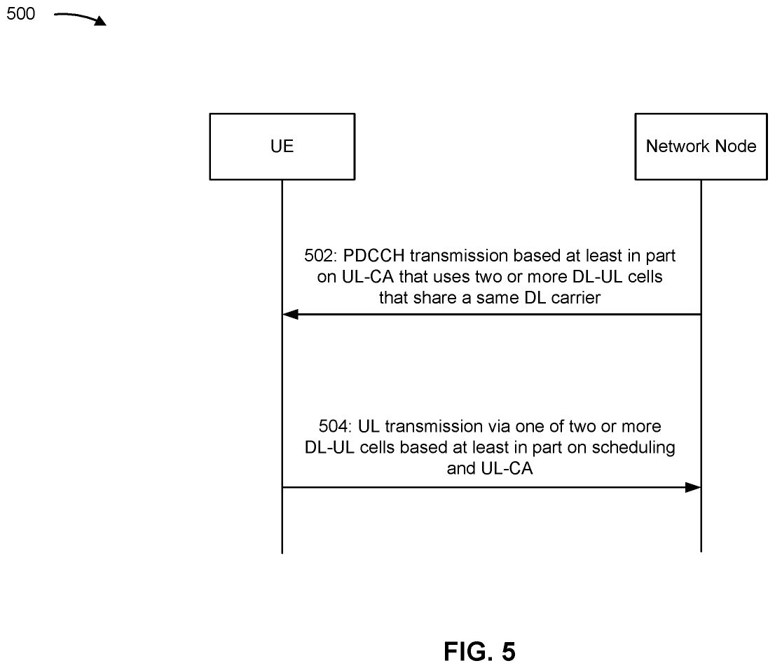

FIG. 5 is a diagram illustrating an example 500 associated with UL-CA using multi-cell DL carrier sharing, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

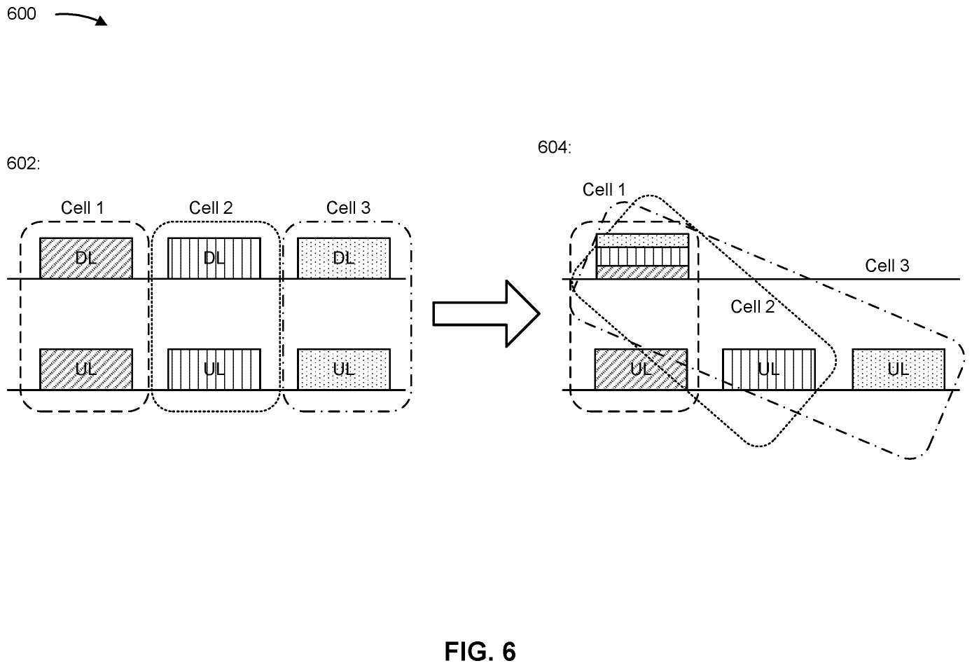

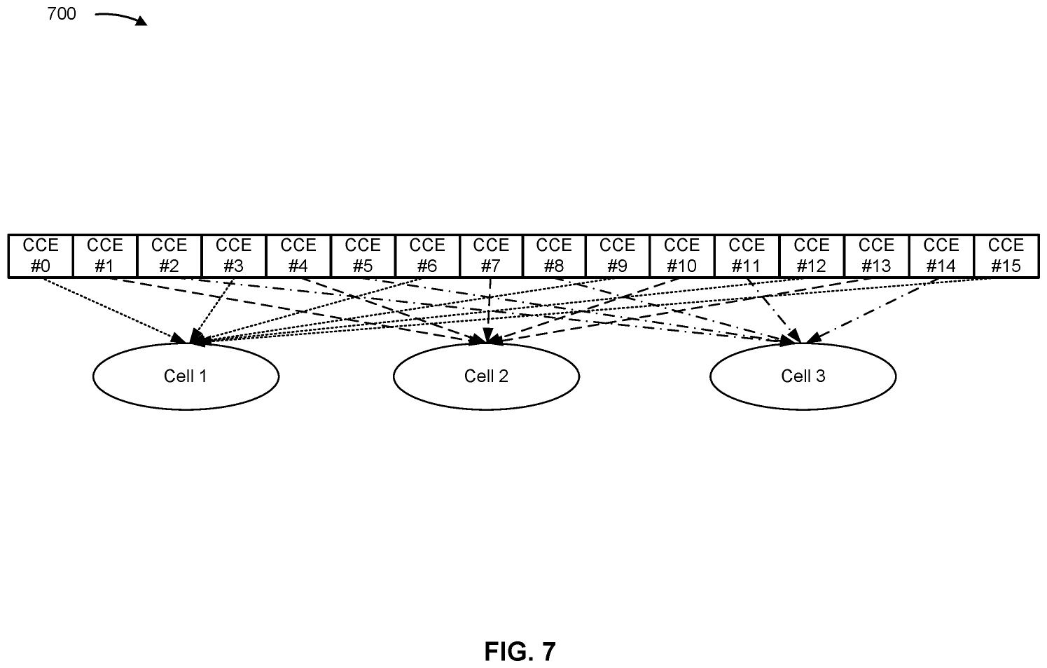

As shown by reference number 502, the UE may receive, from the network node, a PDCCH transmission based at least in part on an UL-CA that uses two or more DL-UL cells that share a same DL carrier (e.g., as shown in FIG. 6), where the two or more DL-UL are based at least in part on a CCE index mapping (e.g., as shown in FIGS. 7, 9, and 11). The UE may receive, from the network node, a serving cell configuration IE that includes a configuration for the two or more DL-UL cells and UL control information, where the DL carrier may be associated with a DL-BWP based at least in part on the configuration.

In some aspects, different CCE indexes may be associated with different DL-UL cells in accordance with a mapping. The mapping may be uniformly circular across the DL-UL cells or non-uniform across the DL-UL cells. The mapping may be static across slots or dynamic across slots. In some aspects, PDCCH candidates from different DL-UL cells may be mapped to different CCE indexing patterns in a CORESET for the UE. Non-contiguous CCE indexes may be mapped to the two or more DL-UL cells based at least in part on a CCE indexing pattern. A non-contiguous starting CCE index for a PDCCH may be mapped to the two or more DL-UL cells based at least in part on the CCE indexing pattern. A non-contiguous starting CCE index and an ending CCE index for a PDCCH may be mapped to the two or more DL-UL cells based at least in part on a CCE indexing pattern. Contiguous CCE indexes may be mapped to the two or more DL-UL cells based at least in part on the CCE indexing pattern.

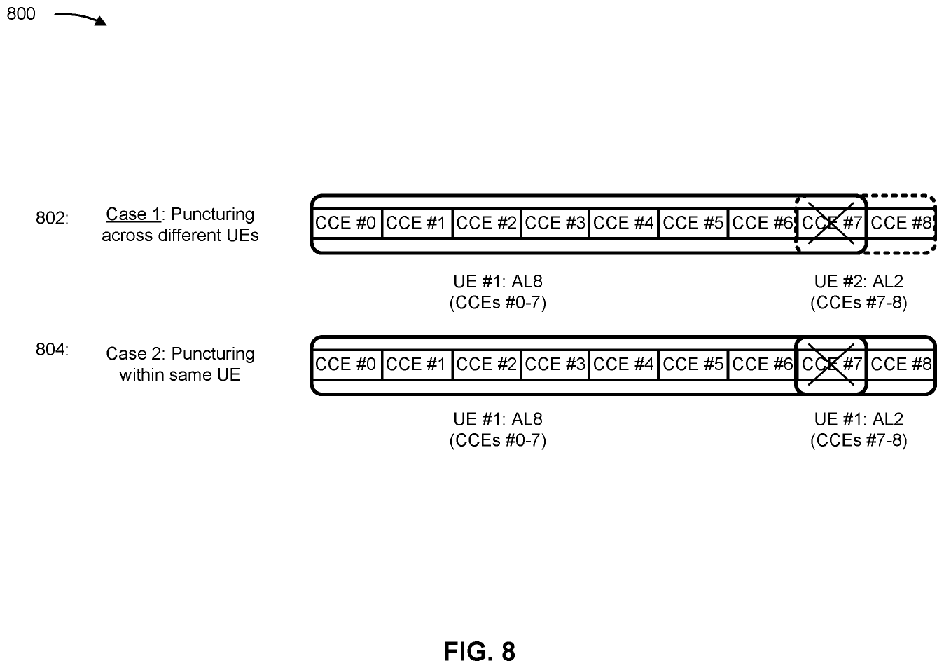

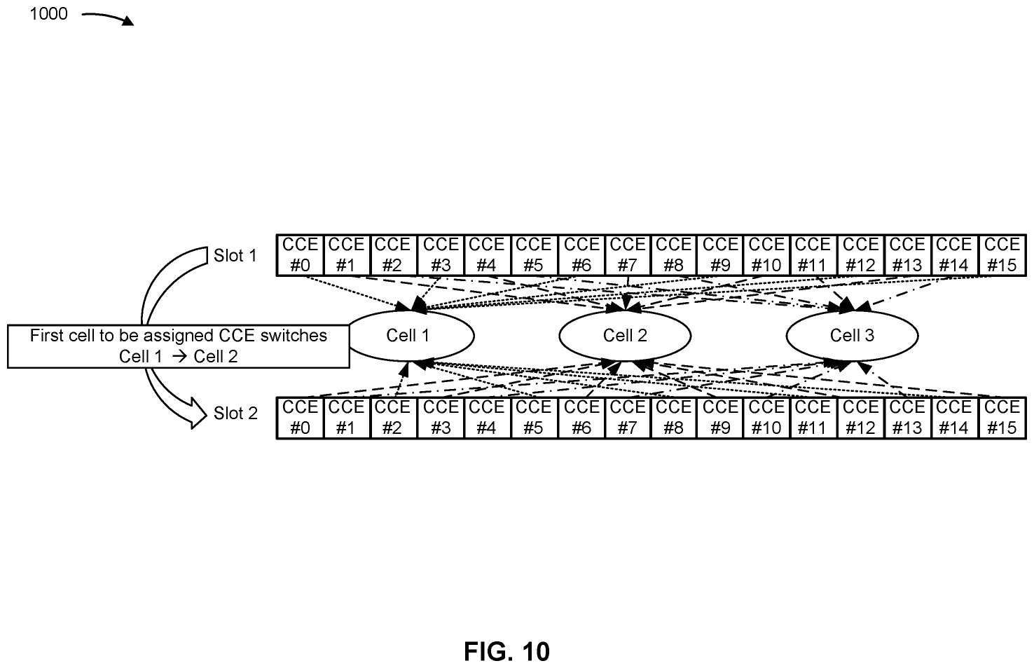

In some aspects, a puncturing of a number of CCEs in a mapped PDCCH candidate may be based at least in part on a CCE indexing pattern (e.g., as shown in FIG. 8). The puncturing may be based at least in part on a PDCCH candidate that cannot be mapped in a slot due to a collision with another PDCCH candidate. The puncturing may be based at least in part on a UE capability report that indicates that the UE is able to handle punctured PDCCH candidates. A maximum number of PDCCH candidates may be specified based at least in part on the UE capability report indicating that the UE is able to monitor PDCCH candidates with contiguously punctured CCEs, or the maximum number of PDCCH candidates may be specified based at least in part on the UE capability report indicating that the UE is able to monitor PDCCH candidates with non-contiguously punctured CCEs. A PDCCH candidate for a particular UE may be punctured and transmitted in two manners. In a first manner, contiguous CCEs in that PDCCH candidate may be punctured. In a second manner, non-contiguous CCEs in that PDCCH candidate may be punctured. In both cases, the UE may need to report that the UE is capable of handling PDCCH candidates. However, an ability to handle contiguously punctured CCEs or non-contiguously punctured CCEs may be different capabilities. In some aspects, the UE may receive, from the network node, a configuration of a CCE indexes mapping to the two or more DL-UL cells, where CCE indexes may be assigned to the two or more DL-UL cells in a dynamic manner (e.g., as shown in FIG. 10).

In some aspects, the UE may receive, from the network node, an indication of cell ordering to indicate CCEs to be monitored. The cell ordering may be based at least in part on an absolute radio frequency channel number (ARFCN), or the cell ordering may be based at least in part on a lowest frequency of a smallest resource block in an UL-BWP. In some aspects, the UE may perform a cell selection based at least in part on a cell select parameter. In some aspects, the UE may perform the cell selection by measuring each DL-UL cell, of the two or more DL-UL cells, and connecting to a DL-UL cell of a highest quality of the two or more DL-UL cells. In some aspects, a mapping of CCEs to PDCCH candidates scheduling a PUSCH transmission in different DL-UL cells may be based at least in part on an aggregation level (AL).

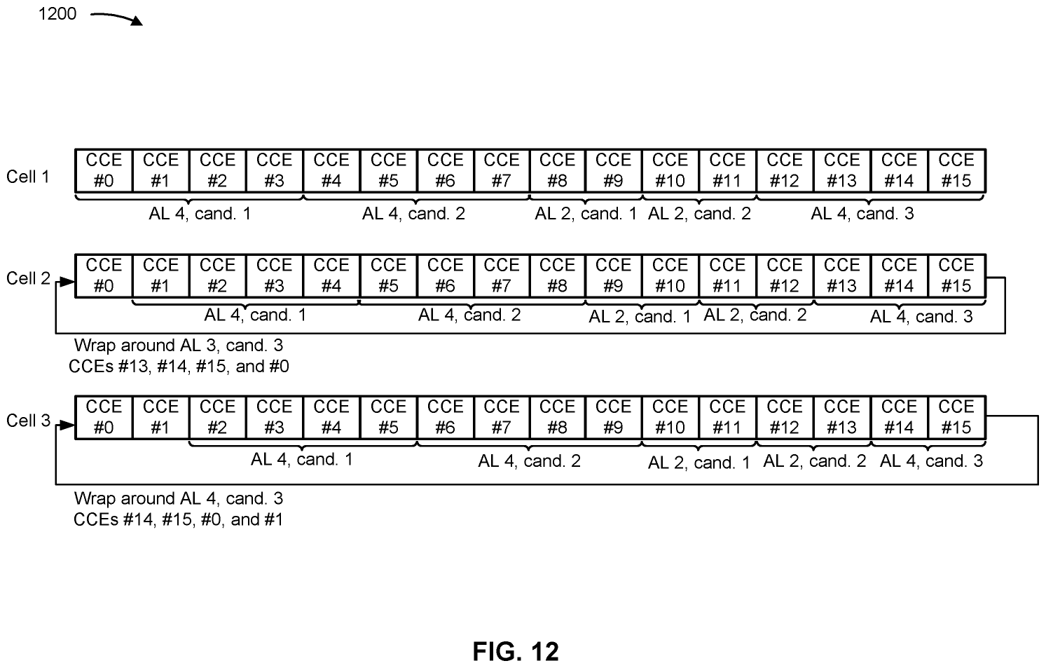

In some aspects, the UE may receive, from the network node, a serving cell index parameter via RRC signaling. A CCE-to-PDCCH hashing function may be based at least in part on the serving cell index parameter. The CCE-to-PDCCH hashing function may include one or more values that are embedded with the serving cell index parameter, or the CCE-to-PDCCH hashing function may be modified to incorporate the serving cell index parameter. The CCE-to-PDCCH hashing function may be modified with a cell-dependent offset and a mod operator to allow each DL-UL cell to observe a same CORESET and a shifted number of CCEs (e.g., as shown in FIG. 12).

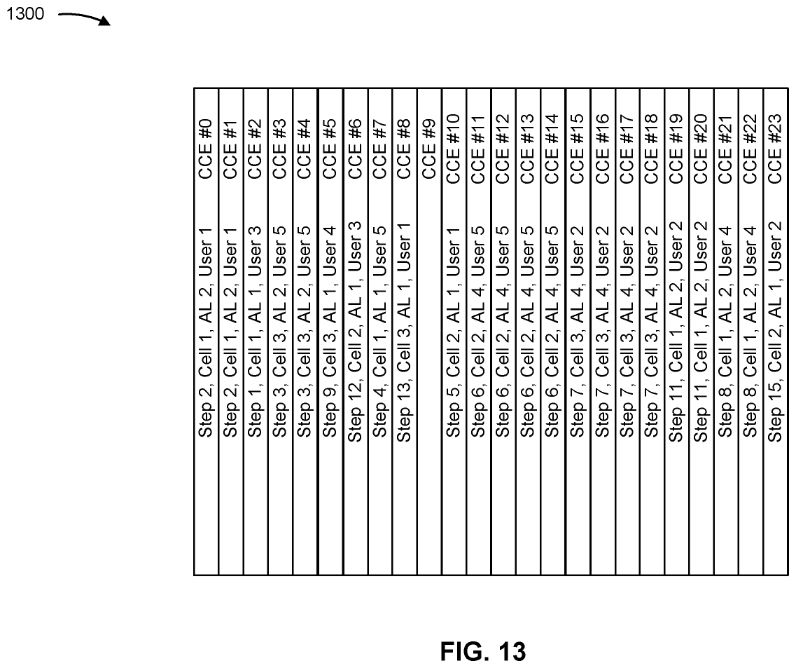

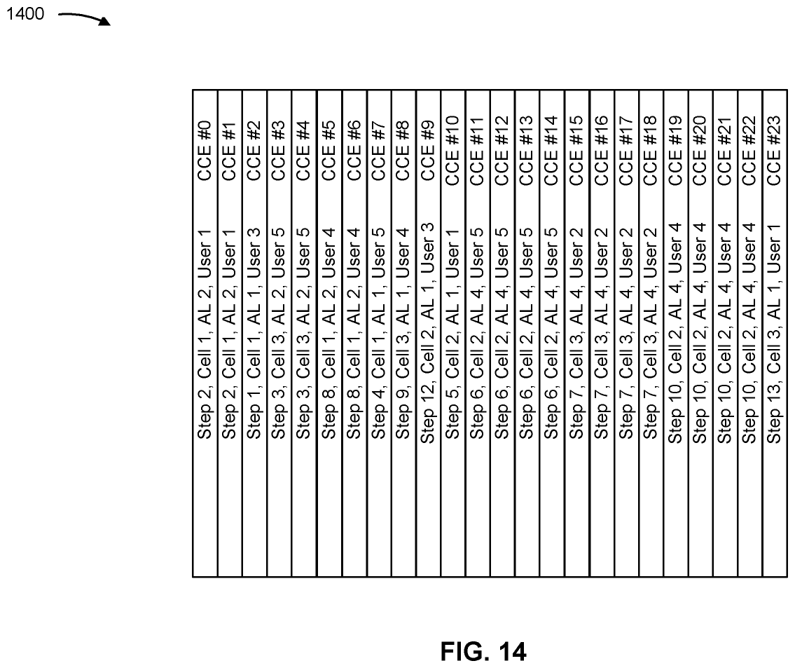

In some aspects, the UE may monitor a starting CCE type PDCCH candidate (e.g., as shown in FIG. 13), or the UE may monitor a starting CCE type and ending CCE type PDCCH candidate (e.g., as shown in FIG. 14). A mapping order of starting CCEs to DL-UL cells may be per UE based at least in part on a network scheduling a PDCCH in a CORESET with a defined number of CCEs. In some aspects, different DL-UL cells may serve different QoS requirements for different use cases and different ALs may be assigned to the different DL-UL cells. In some aspects, a radio network temporary identifier (RNTI) may be configured to distinguish a particular DL-UL cell along a set of carrier aggregation configured DL-UL cells, where a slot number may be useable as a differentiation factor for cell scheduling based at least in part on the RNTI. In some aspects, a UE-specific search space (USS) set numbering may be useable as a differentiation factor for cell scheduling.

As shown by reference number 504, the UE may transmit, to the network node, based at least in part on a scheduling and the UL-CA, an UL transmission via one of the two or more DL-UL cells. The UE may receive, from the network node, an indication of a scheduled DL-UL cell, of the two or more DL-UL cells, for an UL grant. The UL transmission may be based at least in part on the indication. The scheduled DL-UL cell may be associated with a cross-carrier scheduling or a self-carrier scheduling. The indication may be associated with a differentiation for determining the scheduled DL-UL cell, where the differentiation may be based at least in part on a DCI payload or payload size.

As indicated above, FIG. 5 is provided as an example. Other examples may differ from what is described with regard to FIG. 5.

FIG. 6 is a diagram illustrating an example 600 associated with fully overlapping DL carriers, in accordance with the present disclosure.

As shown by reference number 602, legacy per-cell DL and UL may be defined. For example, a first cell may be associated with DL and UL, a second cell may be associated with DL and UL, and so on. As shown by reference number 604, hybrid DL and UL cells may be defined. For example, the same DL carrier may be associated with the first cell, the second cell, and a third cell. In this case, eSUL use cases may be enabled using switched UL or dual UL UL-CA using DL and UL cells sharing the same DL carrier. Fully overlapping DL carriers may be an alternative to UL-only cells. A UE may receive DL control/data from the same DL carrier (shared across cells) and be scheduled to transmit on any of the available UL carriers. Such a scenario may be configured via RRC signaling, which may involve indicating which UL cell the UE is expected to transmit on following a DCI reception.

As indicated above, FIG. 6 is provided as an example. Other examples may differ from what is described with regard to FIG. 6.

In some aspects, a configuration of CA with fully overlapped DL carriers may be defined. eSUL use cases may be enabled using switched UL or dual UL UL-CA using DL and UL cells sharing the same DL carrier. A network node may send a serving cell configuration (ServingCellConfig) IE to configure the cells via RRC signaling. Each DL carrier may have its own DL-BWP configured. A shared cell RNTI (C-RNTI) may be for every DL carrier or a carrier-dependent C-RNTI may be used. Alternatively, a same DL-BWP may be shared across cells. Common control information (including BWP DL common (BWP-DownlinkCommon) information) may be transmitted through a common DL-BWP in a new aggregated BWP downlink common (Aggregated-BWP-DownlinkCommon) IE. UL control information may be included in a serving cell configuration common (ServingCellConfigCommon) IE with a new uplink configuration common (UplinkConfigCommon) IE applicable to this cell cluster. In a first option, a list of per-cell UplinkConfigCommon IEs may be indicated. Each UplinkConfigCommon IE may contain its own initial UL-BWP configuration in an initial UL-BWP (initialUplinkBWP) IE, as well as a frequency information UL (frequencyInfoUL) IE. In a second option, a single UplinkConfigCommon IE may be signaled. A list of initial UL-BWP configurations for each cell may be signaled in per-cell initialUplinkBWP IEs, as well as a list of frequencyInfoUL IEs. The network node may indicate which cell the UEs should connect to, or a UE may decide which cell to connect to depending on a UE implementation. An UL Tx switching may be configured using existing mechanisms.

In some aspects, a scheduling of fully-overlapped carriers may be defined, where a DCI format size may be a differentiation factor. The UE must be notified of the scheduled cell for an UL grant, where differentiation factors may be defined for the UE to determine the targeted cell. In a cross-carrier scheduling, a CIF in DCI may be the differentiation factor. Self-carrier scheduling differentiation factors may also be used. In a self-carrier scheduling, the differentiation factor may be based at least in part on a DCI format size, CCE indexing, AL, C-RNTI, slot number ns, and/or a USS set numbering. Regarding the DCI format size, different cells may have different DCI sizes. For example, two additional bits may be needed to signal a scheduled cell ([log₂ 3]=2). A DCI payload may have 2 additional bits, which may uniquely identify up to 4 cells (discrete entropy if uniform probability). Zero padding is another alternative, e.g., a single extra ‘0’ bit indicates cell 1, ‘00’ indicates cell 2, and so on. An association between a bit combination or a number of zero-padded bits and scheduled cell may be indicated via RRC/DCI using a new variable such as a serving cell index (servingCellIndex). Different DCI format sizes is an example of an explicit indication of scheduled cells.

FIG. 7 is a diagram illustrating an example 700 associated with a scheduling of fully-overlapped carriers, in accordance with the present disclosure.

As shown in FIG. 7, in the scheduling of fully-overlapped carriers, a CCE indexing may be a differentiation factor. CCE indexes may be associated with different cells, where CCE candidate j may be mapped to cell i=mod (j, N_{cells})+1. For example, a first group of CCEs may be mapped to a first cell (cell 1), a second group of CCEs may be mapped to a second cell (cell 2), and a third group of CCEs may be mapped to a third cell (cell 3). A mapping may be uniformly circular across cells or non-uniform. A uniform mapping (e.g., when N_{CCEs}/N_{cells} is integer) may ensure that an equal number of CCEs are allocated to different cells. A non-uniform mapping may be used when some cells are overloaded with UEs to redistribute a CCE allocation depending on the use case. The mapping may also be static across slots or dynamic. For example, a dynamic pseudorandom mapping may be used when security is a fundamental requirement for the use case.

In some aspects, in the CCE indexing, PDCCH candidates from different cells may map to different CCE indexing patterns in a control resource set (CORESET) for a given UE, with different options. For example, five different options may be defined, where the five different options may correspond to CCE indexing as a differentiation factor for uniform mapping.

In some aspects, in a first option, non-contiguous CCE indexes may be mapped to cells, which may result in a blockage-free CCE mapping. A UE may only perform channel estimation on assigned CCEs. A relatively low CCE mapping efficiency may occur when a cell is overloaded, where UEs requiring a higher AL may be in outage. In a 6G system, such behavior may apply to active non-dormant cells to maximize PDCCH allocation efficiency (e.g., a current NR specification does not differentiate between active non-dormant cells and dormant cells). CCEs may be split into active cells and not dormant cells, which may result in higher CCE allocation efficiency and an update wait time of 1 slot. For example, the first cell, the second cell, and the third cell may be active. When the third cell is dormant, all CCEs may be split into the first cell and the second cell, such that odd-numbered CCEs may be allocated for the first cell, and even-numbered CCEs may be allocated for the second cell. Alternatively, when the third cell is dormant, only CCEs #3, #6, #9, #12, and #15 previously mapped to the third cell may be split into the first cell and the second cell, and other CCE mapping may be unaltered. UEs that miss a third cell dormancy indication may still correctly decode PDCCH candidates.

In some aspects, in a second option, a non-contiguous starting CCE index for a PDCCH may map to cells, which may result in a blockage-sensitive CCE mapping. The second option may provide a greater CCE allocation efficiency in an absence of blockage, in relation to the first option, but may have sensitivity to blockage as UEs need to potentially undergo channel estimation in other CCEs. For example, when PDCCH candidate 1 spans CCEs #1-#4 (AL 4), the second cell cannot allocate PDCCH candidate 2 spanning two CCEs in CCE #2, and a minimum CCE index is CCE #5. When the UE cannot be guaranteed an allocation of PDCCH candidates for AL X, the UE's priority may be rolled into a next slot.

In some aspects, in a third option, a non-contiguous starting and ending CCE index for a PDCCH may be mapped to cells, which may result in a blockage-sensitive CCE mapping. The third option may provide a greater CCE allocation efficiency and reduced blockage probability, in relation to the second option, but may have more complexity on a UE PDCCH monitoring process and/or required signaling. In an informed UE approach, a network node may provide an RRC indication of a number of PDCCH candidates that will be of mapping type “starting CCE index” (default) and/or “ending CCE index”, or the network node may provide a per-candidate indication (e.g., different granularity levels of specificity may be allowed). In an uninformed UE approach, the UE may monitor two sets of PDCCH candidates (“starting CCE index” and “ending CCE index”) and may proceed with a blind PDCCH decoding assuming either hypothesis, depending on UE implementation.

In some aspects, in a fourth option, a PDCCH candidate cannot be mapped in a slot due to a collision with another PDCCH candidate. In this case, a puncturing of a number of CCEs in a mapped PDCCH candidate may allow a mapping of a second colliding candidate. Puncturing may be combined with the first option, the second option, and/or the third option. The puncturing may provide greater CCE allocation efficiency and flexibility to prevent blockage, and the puncturing may provide a possibility to define “quasi” AL 3, 6, 7, 9, 10, 11, 12, 13, 14 and 15 without needing to design per-AL rate-matching procedures for punctured AL. The puncturing may be associated with more complexity on UE monitoring process and/or required signaling, which may result in performance loss due to puncturing. For example, an AL4 PDCCH candidate from the first cell spans CCEs #4-#7, an AL8 PDCCH candidate from the third cell spans CCEs #9-#16, and only CCE #8 is unmapped. An AL2 PDCCH candidate from the second cell may span CCEs #8, #7 (ending-CCE type candidate) when CCE #7 from the AL4 candidate from the first cell is punctured.

In some aspects, puncturing a single CCE in an AL2 PDCCH candidate may yield more performance loss than for an AL8 PDCCH candidate. An AL16 PDCCH candidate may support up to 4 CCE puncturing (comparable to AL12 candidate) while an AL8 PDCCH candidate may only support up to 2 CCE puncturing (approximately an AL6 candidate). CCEs punctured may be contiguous or non-contiguous depending on UE capability, and the network node may map some PDCCH candidates with certain priority levels. For each cell, when the UE reports a capability indicating that the UE is able to handle punctured PDCCH candidates, a maximum number of punctured PDCCH candidates may be included to limit a number of blind decodes required to decode DCI. A maximum number of CCEs punctured may be specified per AL and per cell according to a maximum permissible performance loss. When the UE reports a capability indicating that the UE is able to monitor PDCCH candidates with non-contiguously punctured CCEs, a maximum number of such PDCCH candidates may be specified to limit UE complexity. A maximum number of non-contiguously punctured CCEs per AL and per cell may be specified, which may be potentially more restrictive than the corresponding number of contiguously punctured CCEs. Further, puncturing on a UE side may depend on which candidates are being punctured (e.g., as shown in FIG. 8).

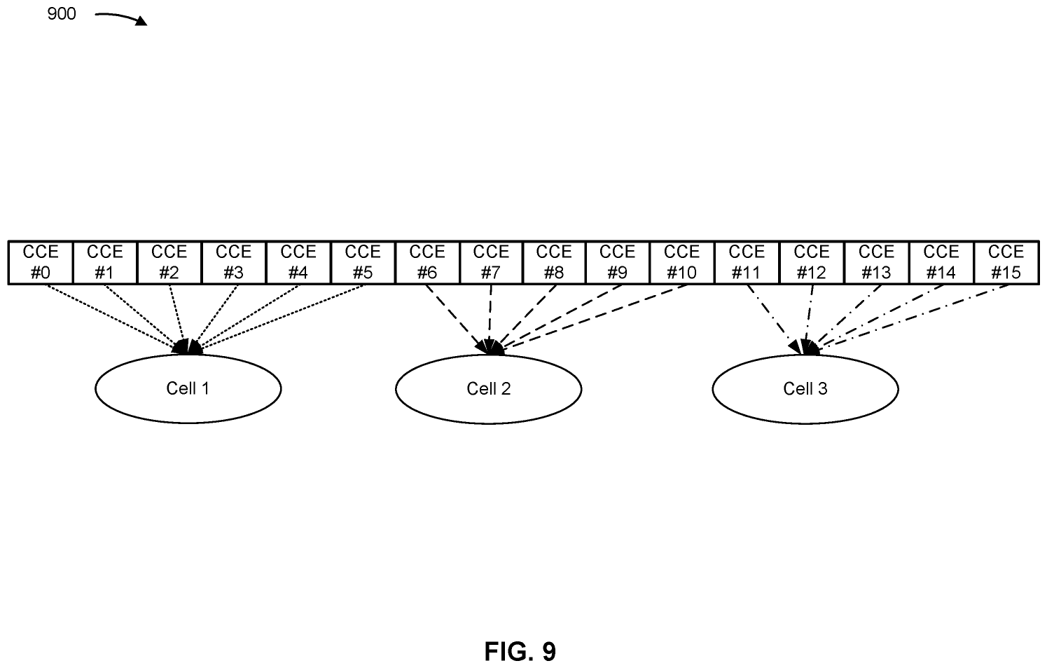

In some aspects, in a fifth option, contiguous CCE indexes may be mapped to cells (e.g., as shown in FIG. 9), which may result in easy to detect PDCCH candidates for each cell and a blockage-free CCE mapping. UEs requiring a relatively large AL may potentially be in outage since no AL8 or AL16 support may be enabled, depending on a number of CCEs in a CORESET and a number of active cells. In the 6G system, such behavior may apply to active non-dormant cells to maximize PDCCH allocation efficiency (e.g., the current NR specification does not differentiate between active non-dormant cells and dormant cells). CCEs may be split into active cells and not dormant cells. For example, the first cell, the second cell, and the third cell may be active. When the third cell is dormant, CCEs #11 to #16 may be split into the first cell and the second cell, such that CCEs #1-#8 may be allocated for the first cell, and CCEs #9-#16 for the second cell.

In some aspects, CCE indexes may be assigned to cells in a dynamic manner (e.g., as shown in FIG. 10). The CCE indexes may be assigned in the dynamic manner (e.g., for options one through five), which may be important for security purposes when combined with pseudo-randomness (e.g., military operations) and important to ensure that every cell gets the same number of CCE indexes when averaged over a large number of slots. A priority-constrained CCE-to-PDCCH mapping on the network node side may be needed for all options, depending on a QoS (e.g., a URLLC use case may have higher priority than eMBB and MTC). The network node may send a configuration of CCE indexes mapping to cells to the UE's monitoring PDCCH candidates in the same CORESET. An indication of an offset and a slot index may be in an Aggregated-BWP-DownlinkCommon IE and/or a PDCCH configuration common (PDCCH-ConfigCommon) IE.

As indicated above, FIG. 7 is provided as an example. Other examples may differ from what is described with regard to FIG. 7.

FIG. 8 is a diagram illustrating an example 800 associated with puncturing, in accordance with the present disclosure.

As shown in FIG. 8, CCE #7 from an AL8 PDCCH candidate scheduling UE #1 may be punctured to map an AL2 candidate from UE #2 and/or UE #1 (two cases). As shown by reference number 802, in a first case involving puncturing across different UEs, UE #1 may need an RRC indication of CCE #7 being punctured, or approximately 1.5 blind decodes (e.g., channel decoding, not channel estimation/equalization). As shown by reference number 804, in a second case involving puncturing within the same UE, UE #1 may know that the AL8 candidate has been punctured implicitly (e.g., only one blind decode per PDCCH candidate).

In some aspects, an explicit puncturing indication may only be needed when a punctured PDCCH candidate and a candidate to be mapped schedule different UEs. During a channel estimation, a UE may realize a CCE has been punctured by comparing noise variance levels of channel estimates corresponding to two CCEs (e.g., CCE #6 and CCE #7). A lowest noise variance level may correspond to a true channel estimate.

As indicated above, FIG. 8 is provided as an example. Other examples may differ from what is described with regard to FIG. 8.

FIG. 9 is a diagram illustrating an example 900 associated with contiguous CCE indexes mapping to cells, in accordance with the present disclosure.

As shown in FIG. 9, contiguous CCE indexes may be mapped to cells, which may result in easy to detect PDCCH candidates for each cell and blockage-free CCE mapping. For example, CCEs #1-#5 may be allocated for a first cell, CCEs #6-#10 for a second cell, and CCEs #11-#15 for a third cell.

As indicated above, FIG. 9 is provided as an example. Other examples may differ from what is described with regard to FIG. 9.

FIG. 10 is a diagram illustrating an example 1000 associated with assigning CCE indexes to cells in a dynamic manner, in accordance with the present disclosure. As shown in FIG. 10, when the CCE indexes are assigned to cells in the dynamic manner, CCE index #1 may be assigned to a first cell in slot 1, a second cell in slot 2, a third cell in slot 3, the first cell in slot 4, and so on. A CCE index j may be assigned to cell mod (mod (j+o, N_{cells})+s, N_{cells})+1≤N_{cells}, j=0, . . . , N_{CCE}−1, where o is the offset and s is the slot index. Thus, a first cell to be assigned a CCE may switch between the first cell and the second cell.

As indicated above, FIG. 10 is provided as an example. Other examples may differ from what is described with regard to FIG. 10.

In some aspects, a cell ordering may be conveyed to a UE for the UE to identify which CCEs to monitor. In a first option, the cell ordering may be based at least in part on an UL cell E-UTRA absolute radio frequency channel number (EARFCN), ordered from smallest to highest. In a second option, the cell ordering may be based at least in part on a lowest frequency of a smallest resource block (RB) index in an UL-BWP, from lowest to highest. For example, a BWP may be associated with a location, a bandwidth, a subcarrier spacing, and/or a cyclic prefix. In the first option, UEs may access an UL cell EARFCN in one or more FrequencyInfoUL IEs within an Aggregated-BWP-UplinkCommon IE or a list of BWP-UplinkCommon IEs. In the second options, UEs may access a frequency of a smallest RB index in a location and bandwidth (locationAndBandwidth) entry within a BWP IE in an Aggregated-BWP-UplinkCommon IE or a list of BWP-UplinkCommon IEs. Even though some UEs May not be configured with UL-CA, the UEs may need this information to determine which CCEs in the CORESET should be monitored for “starting”/“ending”-type PDCCH candidates.

In some aspects, in a UE cell selection, a cell selection by a UE may use an RSRP/RSRQ, or a cell select (cellSelect) parameter. The cellSelect parameter may be sent in DCI (similar to an UL/SUL indicator) or via RRC signaling.

In an example of cell ordering (e.g., cell ordering based at least in part on the UL cell EARFCN or based at least in part on the lowest frequency of the smallest RB index in the UL-BWP), a network node may send an UplinkConfigCommon IE. The UplinkConfigCommon IE may include a frequencyInfoUL IE. The frequencyInfoUL IE may indicate an absolute frequency Point A, which may be associated with an ARFCN value. A UE may order an ARFCN value (ARFCN-ValueNR) for multiple cells or based at least in part on the lowest frequency of the smallest RB index given by a locationAndBandwidth parameter. The locationAndBandwidth parameter may be associated with a BWP-UplinkCommon IE.

In some aspects, in a first option of cell selection, the cellSelect parameter may indicate the cell to which the UE should connect. For example, ARFCN-ValueNR 1=161800 (809 MHz) may be associated with a second cell, ARFCN-ValueNR 2=189000 (945 MHz) may be associated with a third cell, and ARFCN-ValueNR 3=146000 (730 MHz) may be associated with a second cell. In a second option of cell selection, the UE may measure an RSRP/RSRQ of each cell, and then connect to the cell with the highest quality. For example, locationAndBandwidth 1=2750[275·(11−1)+0] may be associated with the first cell, locationAndBandwidth 2=2800 [275·(11−1)+50] may be associated with the second cell, and locationAndBandwidth 3=2860 [275·(11−1)+110] may be associated with the third cell.

In some aspects, limits may be associated with a shared DL CORESET. A mapping of CCEs to PDCCH candidates scheduling PUSCH transmissions in different cells may depend on an AL. For example, for AL1, when there are 16 CCEs, a maximum of 16 cells may be supported simultaneously for UL transmissions. In the same example, for AL2, only 8 cells may be supported on the same CORESET for UL transmissions. When AL16, only one cell may be supported. A minimum number of CCEs required to schedule N_{cells} for AL L is N_{cells}L. When using CA over eSUL (e.g., using eUL-CA), a user throughput may be limited when near a cell edge. A higher AL may be needed to ensure a PDCCH reception. A number of CCEs per CORESET may be increased or different UL transmissions may be scheduled in different slots using different CORESETs, which may incur additional latency.

In some aspects, a CCE indexing differentiation procedure may require changes to a legacy CCE-to-PDCCH hashing function that maps CCEs to PDCCH candidates, where the legacy CCE-to-PDCCH hashing function may be represented by:

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i .$$

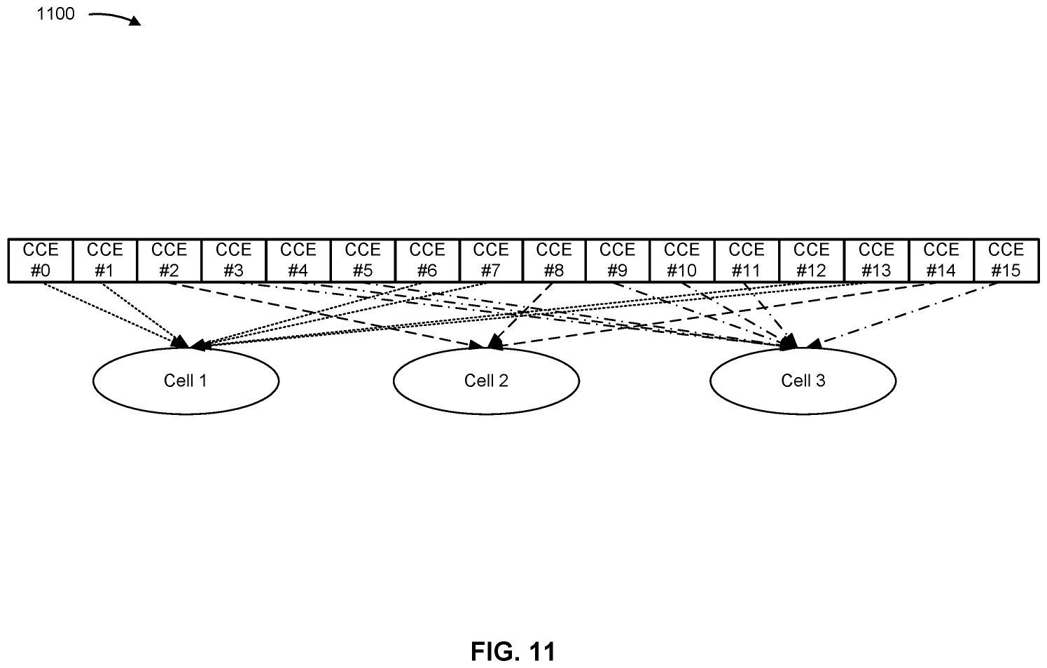

In a first option, the legacy CCE-to-PDCCH hashing function itself may not be modified, and instead an additional variable serving cell index (servingCellIndex) may be embedded within n_{CI}, L, Y_{p,n}_{_{s,f}}_{^{μ}}. In a second option, the legacy CCE-to-PDCCH hashing function may be modified to incorporate servingCellIndex, which may implement a uniform circular mapping. Both options may require signaling the servingCellIndex to the UE via RRC signaling when cells are configured, as well as indicating a first cell to be mapped to CCE candidates (e.g., cell offset). A non-uniform mapping may require an RRC indication of a number of CCEs to be continuously allocated to a particular cell. For example, (2, 1, 3) continuous CCEs allocated may lead to allocation percentages of 37.5%, 18.75% and 43.75%, respectively (e.g., as shown in FIG. 11).

In some aspects, a current hashing function in NR may incorporate UE differentiation using an RNTI for a USS, but may need to include cell differentiation, or a hashing function should be redesigned. For UE and cell differentiation, the following may be used: mod [legacy CCE-to-PDCCH hashing function]+serving CellIndex−1, servingCellIndex=1, . . . , N_{cells}. In this example, the legacy CCE-to-PDCCH hashing function may be modified with the mod and +servingCellIndex−1 to enable cell differentiation. A cell-dependent offset and a wrap-around mod operator may be added to the legacy CCE-to-PDCCH hashing function so that each cell observes the same CORESET but shifted X CCEs, where X is the servingCellIndex−1. This approach may provide considerable degrees of freedom (e.g., a PDCCH candidate scheduling a given cell may not start on a CCE index assigned to that cell). For example, this approach may provide more degrees of freedom than an approach that uses differentiation by cell index first, and then incorporation of a virtual layer in which each user observes a shifted version (for instance) of the CORESET. This approach may be associated with differentiation by UE first, and then incorporation of a per-cell virtual layer in which each cell observes a shifted version of the CORESET, which may also be compatible with puncturing.

FIG. 11 is a diagram illustrating an example 1100 associated with a non-uniform mapping, in accordance with the present disclosure.

As shown in FIG. 11, a non-uniform mapping may require an RRC indication of a number of CCEs to be continuously allocated to a particular cell. For example, (2, 1, 3) continuous CCEs allocated may lead to allocation percentages of 37.5%, 18.75% and 43.75%, respectively.

As indicated above, FIG. 11 is provided as an example. Other examples may differ from what is described with regard to FIG. 11.

FIG. 12 is a diagram illustrating an example 1200 associated with a CCE-to-PDCCH hashing function, in accordance with the present disclosure.

As shown in FIG. 12, the CCE-to-PDCCH hashing function is used for UE and cell differentiation. A first cell may include a plurality of CCEs, where different groups of CCEs are associated with a certain AL and candidate (e.g., AL4 and candidate 1, AL4 and candidate 2, AL2 and candidate 1 and AL2 and candidate 2, and AL4 and candidate 3). A second cell may include a plurality of CCEs, where different groups of CCEs are associated with a certain AL and candidate. A third cell may include a plurality of CCEs, where different groups of CCEs are associated with a certain AL and candidate. In each of the three cells, different CCEs may be associated with different ALs and candidates based at least in part on the CCE-to-PDCCH hashing function used for UE and cell differentiation.

As indicated above, FIG. 12 is provided as an example. Other examples may differ from what is described with regard to FIG. 12.

FIG. 13 is a diagram illustrating an example 1300 associated with a CCE-to-PDCCH mapping, in accordance with the present disclosure.

As shown in FIG. 13, in a CCE-to-PDCCH mapping associated with a non-contiguous starting CCE index for PDCCH mapping to cells, a multicell network may have N_{cells}=3 cells and N_{UE}=5 UEs connected to the cells using UL-CA. A network node may schedule a PDCCH in a shared CORESET with N_{CCE}=24 CCEs. A UE may monitor a “starting-CCE-type” only PDCCH candidate (e.g., one candidate per UE). A mapping order of starting CCEs to cells per UE may be defined. For cell X, an ordering may be a first cell, a second cell, and a third cell. For UE #1: a CCEs number may be mod (0+X−1, 3+X−1, . . . , 21+X−1), e.g., 0, 3, 6, 9, 12, 15, 18, 21 for the first cell. For UE #5, a CCEs number may be mod (4+X−1, 7+X−1, . . . , 25+X−1, N_{CCE}), e.g. 4, 7, 10, 13, 16, 19, 22, 1 for the first cell. For the second cell, an offset of one with respect to a number from the first cell may be added.

In some aspects, a priority mapping may be pseudo-randomly generated. Each candidate may require a different random QoS according to each use case/network need. An AL probability distribution for a 60-bit DCI may be assumed, e.g., AL1=70%, AL2=24%, AL4=6%, A 8=AL16=0%.

As indicated above, FIG. 13 is provided as an example. Other examples may differ from what is described with regard to FIG. 13.

FIG. 14 is a diagram illustrating an example 1400 associated with a CCE-to-PDCCH mapping, in accordance with the present disclosure.

As shown in FIG. 14, in a CCE-to-PDCCH mapping associated with a non-contiguous starting and ending CCE index for PDCCH mapping to cells, a multicell network may have N_{cells}=3 cells and N_{UE}=5 UEs connected to the cells using UL-CA. A network node may schedule a PDCCH in a shared CORESET with N_{CCE}=24 CCEs. A UE may monitor a “starting” and “ending” type PDCCH candidate. A mapping order of starting CCEs to cells per UE may be defined. For cell X, an ordering may be a first cell, a second cell, and a third cell. For UE #1: a CCEs number may be mod (0+X, 3+X, . . . , 21+X), e.g., 0, 3, 6, 9, 12, 15, 18, 21 for the first cell. For UE #5, a CCEs number may be mod (4+X, 7+X, . . . , 25+X, N_{CCE}), e.g. 4, 7, 10, 13, 16, 19, 22, 1 for the first cell. For the second cell, an offset of one with respect to a number from the first cell may be added.

As indicated above, FIG. 14 is provided as an example. Other examples may differ from what is described with regard to FIG. 14.

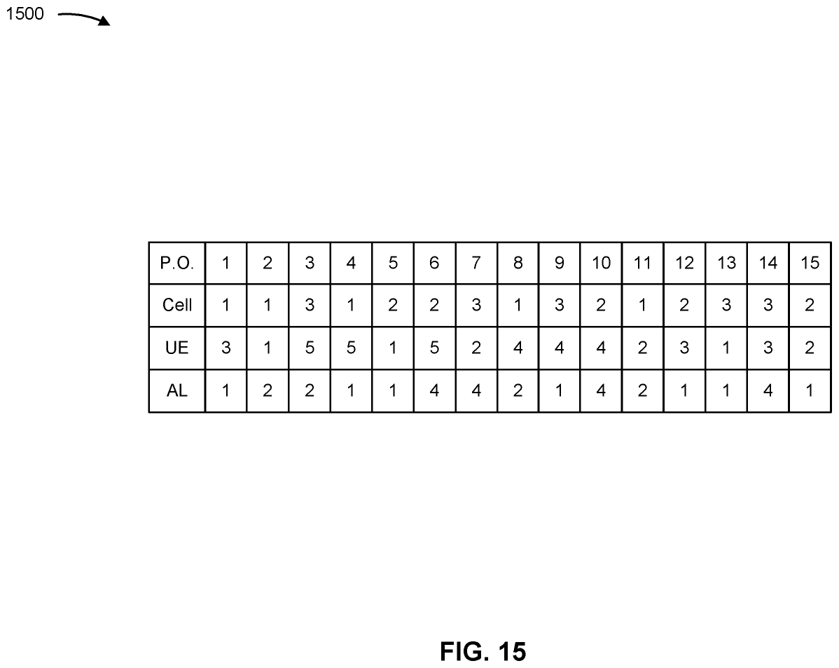

FIG. 15 is a diagram illustrating an example 1500 associated with a priority ordering, in accordance with the present disclosure.

As shown in FIG. 15, a priority ordering (e.g., 1-15) may depend on a cell number (e.g., 1, 2, or 3), a UE (e.g., 1-5), and an AL (e.g., 1-4). The priority ordering may be for a CCE-to-PDCCH mapping associated with a non-contiguous starting CCE index for PDCCH mapping to cells. Alternatively, the priority ordering may be for a CCE-to-PDCCH mapping associated with a non-contiguous starting and ending CCE index for PDCCH mapping to cells.

In some aspects, two UEs may be in blockage (UE #4 in Cell 2, AL 4) and (UE #3 in Cell 3, AL 4) (e.g., as shown in FIG. 13). With a single CCE unoccupied, a CORESET occupancy may be approximately 96%. With 3 cells and 5 UEs in UL-CA and sharing a 24-CCE CORESET, a majority of UEs should be allocated AL1 candidates for mapping to be feasible, with few AL4 candidates. Further, enabling an “ending-CCE” type PDCCH candidate mapping may increase an allocation efficiency, but result in higher UE complexity.

In some aspects, UE #4 may be assigned CCE indexes #4, #7, #10, #13, #16, #19, #22, #1 for a first cell (e.g., as shown in FIG. 14). A PDCCH with a priority ordering 8 (AL2) may be assigned as “ending-type” in CCEs #7, #6. Two UEs may be in blockage, such as UE #2 from cell 1, AL2 candidate and UE #2 from cell 2, AL1 candidate, and UE #3 from cell 3, ALA candidate. Despite more PDCCH candidates being blocked, UE #4 may be scheduled on an AL4 candidate, which may result in a CORESET mapping efficiency of 100%. Lower priority candidates (e.g., high priority ordering) may not be mapped but higher priority AL4 candidate for UE #4 in a second cell may be scheduled.

As indicated above, FIG. 15 is provided as an example. Other examples may differ from what is described with regard to FIG. 15.

In some aspects, in a blockage probability analysis, N_{CCEs}=45 (N_{REG}=270). In a mapping of PDCCH candidates to CCEs, each UE may be scheduled with one PDCCH candidate per cell, and each UE may be assumed to be connected to every cell with UL-CA. A UE may be in blockage when at least one PDCCH candidate scheduling any of the N_{cells} cannot be mapped in a CORESET. A minimal capacity difference may be found between non-contiguous starting CCE index for PDCCH mapping to cells versus non-contiguous starting and ending CCE index for PDCCH mapping to cells. A few extra PDCCH candidates may be mapped with the non-contiguous starting and ending CCE index for PDCCH mapping to cells, but blockage may still exist. A greater capacity difference may be observed in scenarios in which not every UE is configured with UL-CA.

A 6G system may be expected to have various differentiation factors as compared to an NR system. For self-carrier scheduling, an AL, a C-RNTI, and a slot number may not be used in NR. The AL would require PDCCH candidates for different cells to use different AL (non-overlapped). The C-RNTI cannot be used in NR since all carriers use the same C-RNTI when CA is configured. The slot number ns may only be used for USS sets in NR to implement dynamic CCE mapping to PDCCH candidates across slots for different users, depending on user RNTIs. A USS set numbering may be used for PDCCH allocation according to a UE capability, but a UE cannot identify which CCEs/PDCCH candidates correspond to a particular cell prior or after a DCI decoding.

In the 6G system, different cells may serve different QoS requirements for different use cases, and different ALs may be assigned to different cells. An RNTI may be used to distinguish a particular cell among a set of CA-configured cells. The adoption of this RNTI may allow for using the slot number as a differentiation factor for cell scheduling. The USS set numbering may be used as the differentiation factor for cell scheduling when a USS set index is included in DCI and when an RRC indication of which cell with servingCellIndex would map to a particular USS set index (e.g., maximum number of CCEs/PDCCH candidates to avoid overbooking). The USS set numbering may be used as the differentiation factor for cell scheduling when a USS set index is incorporated in a hashing function so that a UE determines which CCEs/PDCCH candidates correspond to a particular USS set index, as well as when an RRC indication of which cell with servingCellIndex would map to a particular USS set index

FIG. 16 is a diagram illustrating an example process 1600 performed, for example, at a UE or an apparatus of a UE, in accordance with the present disclosure. Example process 1600 is an example where the apparatus or the UE (e.g., UE 120) performs operations associated with UL-CC using multi-cell DL carrier sharing.

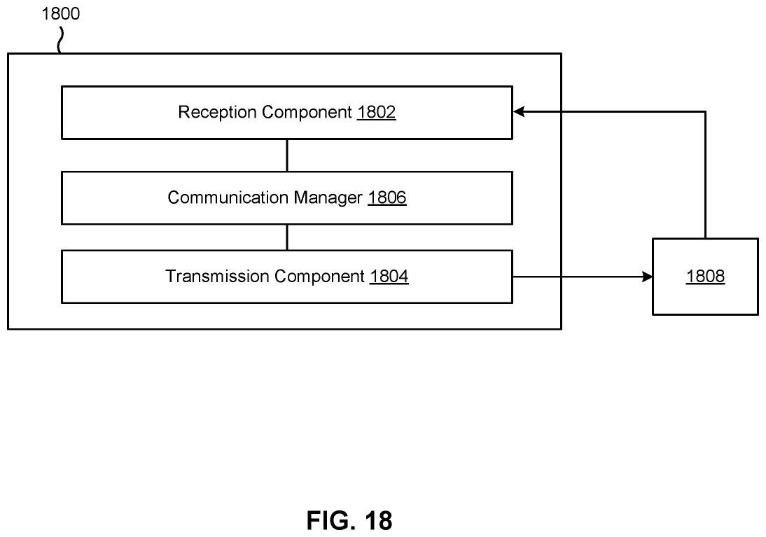

As shown in FIG. 16, in some aspects, process 1600 may include receiving a PDCCH transmission based at least in part on an UL-CA that uses two or more DL-UL cells that share a same DL carrier, wherein the two or more DL-UL cells are based at least in part on a CCE index mapping (block 1610). For example, the UE (e.g., using reception component 1802 and/or communication manager 1806, depicted in FIG. 18) may receive a PDCCH transmission based at least in part on an UL carrier aggregation that uses two or more DL-UL cells that share a same DL carrier, wherein the two or more DL-UL cells are based at least in part on a CCE index mapping, as described above.

As further shown in FIG. 16, in some aspects, process 1600 may include transmitting, based at least in part on a scheduling and the UL-CA, an UL transmission via one of the two or more DL-UL cells (block 1620). For example, the UE (e.g., using transmission component 1804 and/or communication manager 1806, depicted in FIG. 18) may transmit, based at least in part on a scheduling and the UL-CA, an UL transmission via one of the two or more DL-UL cells, as described above.

Process 1600 may include additional aspects, such as any single aspect or any combination of aspects described below and/or in connection with one or more other processes described elsewhere herein.

In a first aspect, process 1600 includes receiving a serving cell configuration IE that includes a configuration for the two or more DL-UL cells and UL control information, wherein the DL carrier is associated with a DL-BWP based at least in part on the configuration.

In a second aspect, alone or in combination with the first aspect, process 1600 includes receiving an indication of a scheduled DL-UL cell, of the two or more DL-UL cells, for an UL grant, wherein the UL transmission is based at least in part on the indication, and the scheduled DL-UL cell is associated with a cross-carrier scheduling or a self-carrier scheduling.

In a third aspect, alone or in combination with one or more of the first and second aspects, the indication is associated with a differentiation for determining the scheduled DL-UL cell, wherein the differentiation is based at least in part on a DCI payload or payload size.

In a fourth aspect, alone or in combination with one or more of the first through third aspects, different CCE indexes are associated with different DL-UL cells in accordance with a mapping, the mapping is uniformly circular across the DL-UL cells or non-uniform across the DL-UL cells, and the mapping is static across slots or dynamic across slots.

In a fifth aspect, alone or in combination with one or more of the first through fourth aspects, PDCCH candidates from different DL-UL cells map to different CCE indexing patterns in a CORESET for the UE.

In a sixth aspect, alone or in combination with one or more of the first through fifth aspects, non-contiguous CCE indexes map to the two or more DL-UL cells based at least in part on a CCE indexing pattern.

In a seventh aspect, alone or in combination with one or more of the first through sixth aspects, a non-contiguous starting CCE index for a PDCCH maps to the two or more DL-UL cells based at least in part on a CCE indexing pattern.

In an eighth aspect, alone or in combination with one or more of the first through seventh aspects, a non-contiguous starting CCE index and an ending CCE index for a PDCCH maps to the two or more DL-UL cells based at least in part on a CCE indexing pattern.

In a ninth aspect, alone or in combination with one or more of the first through eighth aspects, a puncturing of a number of CCEs in a mapped PDCCH candidate is based at least in part on a CCE indexing pattern, wherein the puncturing is based at least in part on a PDCCH candidate that cannot be mapped in a slot due to a collision with another PDCCH candidate.

In a tenth aspect, alone or in combination with one or more of the first through ninth aspects, the puncturing is based at least in part on a UE capability report that indicates that the UE is able to handle punctured PDCCH candidates, and a maximum number of PDCCH candidates is specified based at least in part on the UE capability report indicating that the UE is able to monitor PDCCH candidates with non-contiguously punctured CCEs, or the maximum number of PDCCH candidates is specified based at least in part on the UE capability report indicating that the UE is able to monitor PDCCH candidates with non-contiguously punctured CCEs.

In an eleventh aspect, alone or in combination with one or more of the first through tenth aspects, contiguous CCE indexes map to the two or more DL-UL cells based at least in part on a CCE indexing pattern.

In a twelfth aspect, alone or in combination with one or more of the first through eleventh aspects, process 1600 includes receiving a configuration of a CCE indexes mapping to the two or more DL-UL cells, wherein CCE indexes are assigned to the two or more DL-UL cells in a dynamic manner.

In a thirteenth aspect, alone or in combination with one or more of the first through twelfth aspects, process 1600 includes receiving an indication of cell ordering to indicate CCEs to be monitored, wherein the cell ordering is based at least in part on an ARFCN, or the cell ordering is based at least in part on a lowest frequency of a smallest resource block in an UL-BWP.

In a fourteenth aspect, alone or in combination with one or more of the first through thirteenth aspects, process 1600 includes performing a cell selection based at least in part on a cell select parameter, or performing a cell selection by measuring each DL-UL cell, of the two or more DL-UL cells, and connecting to a DL-UL cell of a highest quality of the two or more DL-UL cells.

In a fifteenth aspect, alone or in combination with one or more of the first through fourteenth aspects, a mapping of CCEs to PDCCH candidates scheduling a PUSCH transmission in different DL-UL cells is based at least in part on an aggregation level.

In a sixteenth aspect, alone or in combination with one or more of the first through fifteenth aspects, process 1600 includes receiving a serving cell index parameter via RRC signaling, wherein a CCE-to-PDCCH hashing function is based at least in part on the serving cell index parameter, wherein the CCE-to-PDCCH hashing function includes one or more values that are embedded with the serving cell index parameter, or the CCE-to-PDCCH hashing function is modified to incorporate the serving cell index parameter.

In a seventeenth aspect, alone or in combination with one or more of the first through sixteenth aspects, the CCE-to-PDCCH hashing function is modified with a cell-dependent offset and a mod operator to allow each DL-UL cell to observe a same CORESET and a shifted number of CCEs.

In an eighteenth aspect, alone or in combination with one or more of the first through seventeenth aspects, process 1600 includes monitoring a starting CCE type PDCCH candidate, or monitoring a starting CCE type and ending CCE type PDCCH candidate, wherein a mapping order of starting CCEs to DL-UL cells is per UE based at least in part on a network scheduling a PDCCH in a shared CORESET with a defined number of CCEs.

In a nineteenth aspect, alone or in combination with one or more of the first through eighteenth aspects, different DL-UL cells serve different QoS requirements for different use cases and different ALs are assigned to the different DL-UL cells, an RNTI is configured to distinguish a particular DL-UL cell along a set of carrier aggregation configured DL-UL cells, wherein a slot number is useable as a differentiation factor for cell scheduling based at least in part on the RNTI, or a USS set numbering is useable as a differentiation factor for cell scheduling.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a network node or an apparatus of a network node, in accordance with the present disclosure. Example process 1700 is an example where the apparatus or the network node (e.g., network node 110) performs operations associated with UL-CC using multi-cell DL carrier sharing.

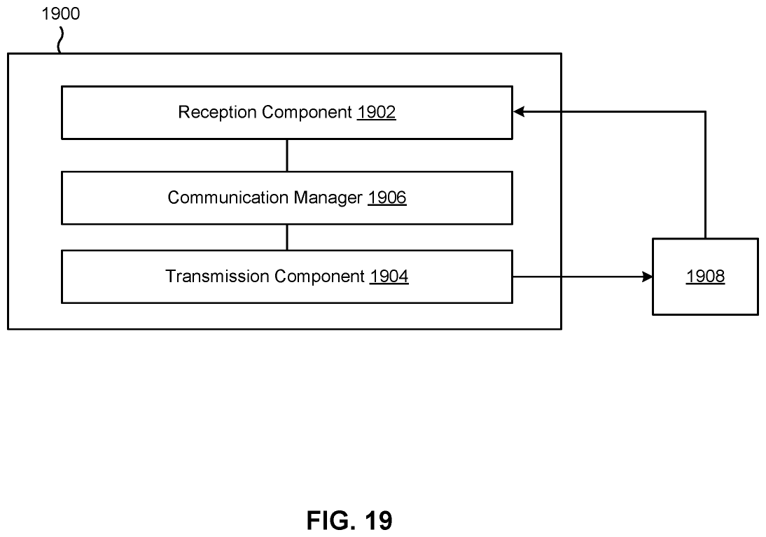

As shown in FIG. 17, in some aspects, process 1700 may include transmitting a PDCCH transmission based at least in part on an UL carrier aggregation that uses two or more DL-UL cells that share a same DL carrier, wherein the two or more DL-UL cells are based at least in part on a CCE index mapping (block 1710). For example, the network node (e.g., using transmission component 1904 and/or communication manager 1906, depicted in FIG. 19) may transmit a PDCCH transmission based at least in part on an UL carrier aggregation that uses two or more DL-UL cells that share a same DL carrier, wherein the two or more DL-UL cells are based at least in part on a CCE index mapping, as described above.

As further shown in FIG. 17, in some aspects, process 1700 may include receiving, based at least in part on a scheduling and the UL-CA, an UL transmission via one of the two or more DL-UL cells (block 1720). For example, the network node (e.g., using reception component 1902 and/or communication manager 1906, depicted in FIG. 19) may receive, based at least in part on a scheduling and the UL-CA, an UL transmission via one of the two or more DL-UL cells, as described above.

Process 1700 may include additional aspects, such as any single aspect or any combination of aspects described below and/or in connection with one or more other processes described elsewhere herein.

In a first aspect, process 1700 includes transmitting a serving cell configuration IE that includes a configuration for the two or more DL-UL cells and UL control information, wherein the DL carrier is associated with a DL-BWP based at least in part on the configuration.

In a second aspect, alone or in combination with the first aspect, process 1700 includes transmitting an indication of a scheduled DL-UL cell, of the two or more DL-UL cells, for an UL grant, wherein the UL transmission is based at least in part on the indication, and the scheduled DL-UL cell is associated with a cross-carrier scheduling or a self-carrier scheduling.

In a third aspect, alone or in combination with one or more of the first and second aspects, the indication is associated with a differentiation for determining the scheduled DL-UL cell, wherein the differentiation is based at least in part on a DCI payload or payload size.

In a fourth aspect, alone or in combination with one or more of the first through third aspects, different CCE indexes are associated with different DL-UL cells in accordance with a mapping, the mapping is uniformly circular across the DL-UL cells or non-uniform across the DL-UL cells, and the mapping is static across slots or dynamic across slots.

In a fifth aspect, alone or in combination with one or more of the first through fourth aspects, PDCCH candidates from different DL-UL cells map to different CCE indexing patterns in a CORESET.

In a sixth aspect, alone or in combination with one or more of the first through fifth aspects, non-contiguous CCE indexes map to the two or more DL-UL cells based at least in part on a CCE indexing pattern.

In a seventh aspect, alone or in combination with one or more of the first through sixth aspects, a non-contiguous starting CCE index for a PDCCH maps to the two or more DL-UL cells based at least in part on a CCE indexing pattern.

In an eighth aspect, alone or in combination with one or more of the first through seventh aspects, a non-contiguous starting CCE index and an ending CCE index for a PDCCH maps to the two or more DL-UL cells based at least in part on a CCE indexing pattern.

In a ninth aspect, alone or in combination with one or more of the first through eighth aspects, a puncturing of a number of CCEs in a mapped PDCCH candidate is based at least in part on a CCE indexing pattern, wherein the puncturing is based at least in part on a PDCCH candidate that cannot be mapped in a slot due to a collision with another PDCCH candidate.

In a tenth aspect, alone or in combination with one or more of the first through ninth aspects, the puncturing is based at least in part on a UE capability report that indicates that a UE is able to handle punctured PDCCH candidates, and a maximum number of PDCCH candidates is specified based at least in part on the UE capability report indicating that the UE is able to monitor PDCCH candidates with non-contiguously punctured CCEs, or the maximum number of PDCCH candidates is specified based at least in part on the UE capability report indicating that the UE is able to monitor PDCCH candidates with non-contiguously punctured CCEs.

In an eleventh aspect, alone or in combination with one or more of the first through tenth aspects, contiguous CCE indexes map to the two or more DL-UL cells based at least in part on a CCE indexing pattern.

In a twelfth aspect, alone or in combination with one or more of the first through eleventh aspects, process 1700 includes transmitting a configuration of a CCE indexes mapping to the two or more DL-UL cells, wherein CCE indexes are assigned to the two or more DL-UL cells in a dynamic manner.

In a thirteenth aspect, alone or in combination with one or more of the first through twelfth aspects, process 1700 includes transmitting an indication of cell ordering to indicate CCEs to be monitored, wherein the cell ordering is based at least in part on an ARFCN, or the cell ordering is based at least in part on a lowest frequency of a smallest resource block in an UL-BWP.

In a fourteenth aspect, alone or in combination with one or more of the first through thirteenth aspects, a mapping of CCEs to PDCCH candidates scheduling a PUSCH transmission in different DL-UL cells is based at least in part on an aggregation level.

In a fifteenth aspect, alone or in combination with one or more of the first through fourteenth aspects, process 1700 includes transmitting a serving cell index parameter via RRC signaling, wherein a CCE-to-PDCCH hashing function is based at least in part on the serving cell index parameter, wherein the CCE-to-PDCCH hashing function includes one or more values that are embedded with the serving cell index parameter, or the CCE-to-PDCCH hashing function is modified to incorporate the serving cell index parameter.

In a sixteenth aspect, alone or in combination with one or more of the first through fifteenth aspects, the CCE-to-PDCCH hashing function is modified with a cell-dependent offset and a mod operator to allow each DL-UL cell to observe a same CORESET and a shifted number of CCEs.

In a seventeenth aspect, alone or in combination with one or more of the first through sixteenth aspects, different DL-UL cells serve different QoS requirements for different use cases and different ALs are assigned to the different DL-UL cells, an RNTI is configured to distinguish a particular DL-UL cell along a set of carrier aggregation configured DL-UL cells, wherein a slot number is useable as a differentiation factor for cell scheduling based at least in part on the RNTI, or a USS set numbering is useable as a differentiation factor for cell scheduling.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication, in accordance with the present disclosure. The apparatus 1800 may be a UE, or a UE may include the apparatus 1800. In some aspects, the apparatus 1800 includes a reception component 1802, a transmission component 1804, and/or a communication manager 1806, which may be in communication with one another (for example, via one or more buses and/or one or more other components). In some aspects, the communication manager 1806 is the communication manager 140 described in connection with FIG. 1. As shown, the apparatus 1800 may communicate with another apparatus 1808, such as a UE or a network node (such as a CU, a DU, an RU, or a base station), using the reception component 1802 and the transmission component 1804.

In some aspects, the apparatus 1800 may be configured to perform one or more operations described herein in connection with FIGS. 5-15. Additionally, or alternatively, the apparatus 1800 may be configured to perform one or more processes described herein, such as process 1600 of FIG. 16, or a combination thereof. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1808. In some aspects, the transmission component 1804 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1804 may be co-located with the reception component 1802 in one or more transceivers.

The communication manager 1806 may support operations of the reception component 1802 and/or the transmission component 1804. For example, the communication manager 1806 may receive information associated with configuring reception of communications by the reception component 1802 and/or transmission of communications by the transmission component 1804. Additionally, or alternatively, the communication manager 1806 may generate and/or provide control information to the reception component 1802 and/or the transmission component 1804 to control reception and/or transmission of communications.

The reception component 1802 may receive a PDCCH transmission based at least in part on an UL carrier aggregation that uses two or more DL-UL cells that share a same DL carrier, wherein the two or more DL-UL cells are based at least in part on a CCE index mapping. The transmission component 1804 may transmit, based at least in part on a scheduling and the UL-CA, an UL transmission via one of the two or more DL-UL cells.

The reception component 1802 may receive a serving cell configuration IE that includes a configuration for the two or more DL-UL cells and UL control information, wherein the DL carrier is associated with a DL-BWP based at least in part on the configuration. The reception component 1802 may receive an indication of a scheduled DL-UL cell, of the two or more DL-UL cells, for an UL grant, wherein the UL transmission is based at least in part on the indication, and the scheduled DL-UL cell is associated with a cross-carrier scheduling or a self-carrier scheduling.

The reception component 1802 may receive a configuration of a CCE indexes mapping to the two or more DL-UL cells, wherein CCE indexes are assigned to the two or more DL-UL cells in a dynamic manner. The reception component 1802 may receive an indication of cell ordering to indicate CCEs to be monitored, wherein the cell ordering is based at least in part on an ARFCN, or the cell ordering is based at least in part on a lowest frequency of a smallest resource block in an UL-BWP.

The communication manager 1806 may perform a cell selection based at least in part on a cell select parameter. The communication manager 1806 may perform a cell selection by measuring each DL-UL cell, of the two or more DL-UL cells, and connecting to a DL-UL cell of a highest quality of the two or more DL-UL cells.

The reception component 1802 may receive a serving cell index parameter via RRC signaling, wherein a CCE-to-PDCCH hashing function is based at least in part on the serving cell index parameter, wherein the CCE-to-PDCCH hashing function includes one or more values that are embedded with the serving cell index parameter, or the CCE-to-PDCCH hashing function is modified to incorporate the serving cell index parameter. The communication manager 1806 may monitor a starting CCE type PDCCH candidate. The communication manager 1806 may monitor a starting CCE type and ending CCE type PDCCH candidate wherein a mapping order of starting CCEs to DL-UL cells is per UE based at least in part on a network scheduling a PDCCH in a shared CORESET with a defined number of CCEs.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication, in accordance with the present disclosure. The apparatus 1900 may be a network node, or a network node may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904.

In some aspects, the apparatus 1900 may be configured to perform one or more operations described herein in connection with FIGS. 5-15. Additionally, or alternatively, the apparatus 1900 may be configured to perform one or more processes described herein, such as process 1700 of FIG. 17, or a combination thereof. In some aspects, the apparatus 1900 and/or one or more components shown in FIG. 19 may include one or more components of the network node described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1902 and/or the transmission component 1904 may include or may be included in a network interface. The network interface may be configured to obtain and/or output signals for the apparatus 1900 via one or more communications links, such as a backhaul link, a midhaul link, and/or a fronthaul link.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1908. In some aspects, the transmission component 1904 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1904 may be co-located with the reception component 1902 in one or more transceivers.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The transmission component 1904 may transmit a PDCCH transmission based at least in part on an UL carrier aggregation that uses two or more DL-UL cells that share a same DL carrier, wherein the two or more DL-UL cells are based at least in part on a CCE index mapping. The reception component 1902 may receive, based at least in part on a scheduling and the UL-CA, an UL transmission via one of the two or more DL-UL cells.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:

Aspect 1: A method of wireless communication performed by a user equipment (UE), comprising: receiving a physical downlink (DL) control channel (PDCCH) transmission based at least in part on an uplink (UL) carrier aggregation that uses two or more DL-UL cells that share a same DL carrier, wherein the two or more DL-UL cells are based at least in part on a control channel element (CCE) index mapping; and transmitting, based at least in part on a scheduling and the UL-CA, an UL transmission via one of the two or more DL-UL cells.

Aspect 2: The method of Aspect 1, further comprising: receiving a serving cell configuration information element (IE) that includes a configuration for the two or more DL-UL cells and UL control information, wherein the DL carrier is associated with a DL bandwidth part (DL-BWP) based at least in part on the configuration.

Aspect 3: The method of any of Aspects 1-2, further comprising: receiving an indication of a scheduled DL-UL cell, of the two or more DL-UL cells, for an UL grant, wherein the UL transmission is based at least in part on the indication, and the scheduled DL-UL cell is associated with a cross-carrier scheduling or a self-carrier scheduling.

Aspect 4: The method of Aspect 3, wherein the indication is associated with a differentiation for determining the scheduled DL-UL cell, wherein the differentiation is based at least in part on a downlink control information (DCI) payload or payload size.

Aspect 5: The method of any of Aspects 1-4, wherein different CCE indexes are associated with different DL-UL cells in accordance with a mapping, the mapping is uniformly circular across the DL-UL cells or non-uniform across the DL-UL cells, and the mapping is static across slots or dynamic across slots.

Aspect 6: The method of any of Aspects 1-5, wherein PDCCH candidates from different DL-UL cells map to different CCE indexing patterns in a control resource set (CORESET) for the UE.

Aspect 7: The method of any of Aspects 1-6, wherein non-contiguous CCE indexes map to the two or more DL-UL cells based at least in part on a CCE indexing pattern.

Aspect 8: The method of any of Aspects 1-7, wherein a non-contiguous starting CCE index for a PDCCH maps to the two or more DL-UL cells based at least in part on a CCE indexing pattern.

Aspect 9: The method of any of Aspects 1-8, wherein a non-contiguous starting CCE index and an ending CCE index for a PDCCH maps to the two or more DL-UL cells based at least in part on a CCE indexing pattern.

Aspect 10: The method of any of Aspects 1-9, wherein a puncturing of a number of CCEs in a mapped PDCCH candidate is based at least in part on a CCE indexing pattern, wherein the puncturing is based at least in part on a PDCCH candidate that cannot be mapped in a slot due to a collision with another PDCCH candidate.

Aspect 11: The method of Aspect 10, wherein the puncturing is based at least in part on a UE capability report that indicates that the UE is able to handle punctured PDCCH candidates, and a maximum number of PDCCH candidates is specified based at least in part on the UE capability report indicating that the UE is able to monitor PDCCH candidates with non-contiguously punctured CCEs, or the maximum number of PDCCH candidates is specified based at least in part on the UE capability report indicating that the UE is able to monitor PDCCH candidates with non-contiguously punctured CCEs.

Aspect 12: The method of any of Aspects 1-11, wherein contiguous CCE indexes map to the two or more DL-UL cells based at least in part on a CCE indexing pattern.

Aspect 13: The method of any of Aspects 1-12, further comprising: receiving a configuration of a CCE indexes mapping to the two or more DL-UL cells, wherein CCE indexes are assigned to the two or more DL-UL cells in a dynamic manner.

Aspect 14: The method of any of Aspects 1-13, further comprising: receiving an indication of cell ordering to indicate CCEs to be monitored, wherein the cell ordering is based at least in part on an absolute radio frequency channel number (ARFCN), or the cell ordering is based at least in part on a lowest frequency of a smallest resource block in an UL bandwidth part (BWP).

Aspect 15: The method of any of Aspects 1-14, further comprising: performing a cell selection based at least in part on a cell select parameter; or performing a cell selection by measuring each DL-UL cell, of the two or more DL-UL cells, and connecting to a DL-UL cell of a highest quality of the two or more DL-UL cells.

Aspect 16: The method of any of Aspects 1-15, wherein a mapping of CCEs to PDCCH candidates scheduling a physical uplink shared channel (PUSCH) transmission in different DL-UL cells is based at least in part on an aggregation level.

Aspect 17: The method of any of Aspects 1-16, further comprising: receiving a serving cell index parameter via radio resource control (RRC) signaling, wherein a CCE-to-PDCCH hashing function is based at least in part on the serving cell index parameter, wherein the CCE-to-PDCCH hashing function includes one or more values that are embedded with the serving cell index parameter, or the CCE-to-PDCCH hashing function is modified to incorporate the serving cell index parameter.

Aspect 18: The method of Aspect 17, wherein the CCE-to-PDCCH hashing function is modified with a cell-dependent offset and a mod operator to allow each DL-UL cell to observe a same control resource set (CORESET) and a shifted number of CCEs.

Aspect 19: The method of any of Aspects 1-18, further comprising: monitoring a starting CCE type PDCCH candidate; or monitoring a starting CCE type and ending CCE type PDCCH candidate, wherein a mapping order of starting CCEs to DL-UL cells is per UE based at least in part on a network scheduling a PDCCH in a shared control resource set (CORESET) with a defined number of CCEs.

Aspect 20: The method of any of Aspects 1-19, wherein: different DL-UL cells serve different quality of service (QOS) requirements for different use cases and different aggregation levels (ALs) are assigned to the different DL-UL cells; a radio network temporary identifier (RNTI) is configured to distinguish a particular DL-UL cell along a set of carrier aggregation configured DL-UL cells, wherein a slot number is useable as a differentiation factor for cell scheduling based at least in part on the RNTI; or a UE-specific search space (USS) set numbering is useable as a differentiation factor for cell scheduling.

Aspect 21: A method of wireless communication performed by a network node, comprising: transmitting a physical downlink (DL) control channel (PDCCH) transmission based at least in part on an uplink (UL) carrier aggregation that uses two or more DL-UL cells that share a same DL carrier, wherein the two or more DL-UL cells are based at least in part on a control channel element (CCE) index mapping; and receiving, based at least in part on a scheduling and the UL-CA, an UL transmission via one of the two or more DL-UL cells.

Aspect 22: The method of Aspect 21, further comprising: transmitting a serving cell configuration information element (IE) that includes a configuration for the two or more DL-UL cells and UL control information, wherein the DL carrier is associated with a DL bandwidth part (DL-BWP) based at least in part on the configuration.

Aspect 23: The method of any of Aspects 21-22, further comprising: transmitting an indication of a scheduled DL-UL cell, of the two or more DL-UL cells, for an UL grant, wherein the UL transmission is based at least in part on the indication, and the scheduled DL-UL cell is associated with a cross-carrier scheduling or a self-carrier scheduling.

Aspect 24: The method of Aspect 23, wherein the indication is associated with a differentiation for determining the scheduled DL-UL cell, wherein the differentiation is based at least in part on a downlink control information (DCI) payload or payload size.

Aspect 25: The method of any of Aspects 21-24, wherein different CCE indexes are associated with different DL-UL cells in accordance with a mapping, the mapping is uniformly circular across the DL-UL cells or non-uniform across the DL-UL cells, and the mapping is static across slots or dynamic across slots.

Aspect 26: The method of any of Aspects 21-25, wherein PDCCH candidates from different DL-UL cells map to different CCE indexing patterns in a control resource set (CORESET).

Aspect 27: The method of any of Aspects 21-26, wherein non-contiguous CCE indexes map to the two or more DL-UL cells based at least in part on a CCE indexing pattern.

Aspect 28: The method of any of Aspects 21-27, wherein a non-contiguous starting CCE index for a PDCCH maps to the two or more DL-UL cells based at least in part on a CCE indexing pattern.

Aspect 29: The method of any of Aspects 21-28, wherein a non-contiguous starting CCE index and an ending CCE index for a PDCCH maps to the two or more DL-UL cells based at least in part on a CCE indexing pattern.

Aspect 30: The method of any of Aspects 21-29, wherein a puncturing of a number of CCEs in a mapped PDCCH candidate is based at least in part on a CCE indexing pattern, wherein the puncturing is based at least in part on a PDCCH candidate that cannot be mapped in a slot due to a collision with another PDCCH candidate.

Aspect 31: The method of Aspect 30, wherein the puncturing is based at least in part on a UE capability report that indicates that a user equipment (UE) is able to handle punctured PDCCH candidates, and a maximum number of PDCCH candidates is specified based at least in part on the UE capability report indicating that the UE is able to monitor PDCCH candidates with non-contiguously punctured CCEs, or the maximum number of PDCCH candidates is specified based at least in part on the UE capability report indicating that the UE is able to monitor PDCCH candidates with non-contiguously punctured CCEs.

Aspect 32: The method of any of Aspects 21-31, wherein contiguous CCE indexes map to the two or more DL-UL cells based at least in part on a CCE indexing pattern.

Aspect 33: The method of any of Aspects 21-32, further comprising: transmitting a configuration of a CCE indexes mapping to the two or more DL-UL cells, wherein CCE indexes are assigned to the two or more DL-UL cells in a dynamic manner.

Aspect 34: The method of any of Aspects 21-33, further comprising: transmitting an indication of cell ordering to indicate CCEs to be monitored, wherein the cell ordering is based at least in part on an absolute radio frequency channel number (ARFCN), or the cell ordering is based at least in part on a lowest frequency of a smallest resource block in an UL bandwidth part (BWP).

Aspect 35: The method of any of Aspects 21-34, wherein a mapping of CCEs to PDCCH candidates scheduling a physical uplink shared channel (PUSCH) transmission in different DL-UL cells is based at least in part on an aggregation level.

Aspect 36: The method of any of Aspects 21-35, further comprising: transmitting a serving cell index parameter via radio resource control (RRC) signaling, wherein a CCE-to-PDCCH hashing function is based at least in part on the serving cell index parameter, wherein the CCE-to-PDCCH hashing function includes one or more values that are embedded with the serving cell index parameter, or the CCE-to-PDCCH hashing function is modified to incorporate the serving cell index parameter.

Aspect 37: The method of Aspect 36, wherein the CCE-to-PDCCH hashing function is modified with a cell-dependent offset and a mod operator to allow each DL-UL cell to observe a same control resource set (CORESET) and a shifted number of CCEs.

Aspect 38: The method of any of Aspects 21-37, wherein: different DL-UL cells serve different quality of service (QOS) requirements for different use cases and different aggregation levels (ALs) are assigned to the different DL-UL cells; a radio network temporary identifier (RNTI) is configured to distinguish a particular DL-UL cell along a set of carrier aggregation configured DL-UL cells, wherein a slot number is useable as a differentiation factor for cell scheduling based at least in part on the RNTI; or a UE-specific search space (USS) set numbering is useable as a differentiation factor for cell scheduling.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 40: An apparatus for wireless communication at a device, the apparatus comprising one or more memories and one or more processors coupled to the one or more memories, the one or more processors configured to cause the device to perform the method of one or more of Aspects 1-20.

Aspect 41: An apparatus for wireless communication, the apparatus comprising at least one means for performing the method of one or more of Aspects 1-20.

Aspect 42: A non-transitory computer-readable medium storing code for wireless communication, the code comprising instructions executable by one or more processors to perform the method of one or more of Aspects 1-20.

Aspect 43: A non-transitory computer-readable medium storing a set of instructions for wireless communication, the set of instructions comprising one or more instructions that, when executed by one or more processors of a device, cause the device to perform the method of one or more of Aspects 1-20.

Aspect 44: A device for wireless communication, the device comprising a processing system that includes one or more processors and one or more memories coupled with the one or more processors, the processing system configured to cause the device to perform the method of one or more of Aspects 1-20.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 21-38.

Aspect 47: An apparatus for wireless communication at a device, the apparatus comprising one or more memories and one or more processors coupled to the one or more memories, the one or more processors configured to cause the device to perform the method of one or more of Aspects 21-38.

Aspect 48: An apparatus for wireless communication, the apparatus comprising at least one means for performing the method of one or more of Aspects 21-38.

Aspect 49: A non-transitory computer-readable medium storing code for wireless communication, the code comprising instructions executable by one or more processors to perform the method of one or more of Aspects 21-38.

Aspect 50: A non-transitory computer-readable medium storing a set of instructions for wireless communication, the set of instructions comprising one or more instructions that, when executed by one or more processors of a device, cause the device to perform the method of one or more of Aspects 21-38.

Aspect 51: A device for wireless communication, the device comprising a processing system that includes one or more processors and one or more memories coupled with the one or more processors, the processing system configured to cause the device to perform the method of one or more of Aspects 21-38.

Aspect 52: An apparatus for wireless communication at a device, the apparatus comprising one or more memories and one or more processors coupled to the one or more memories, the one or more processors individually or collectively configured to cause the device to perform the method of one or more of Aspects 21-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus of wireless communication, comprising:
one or more memories; and
one or more processors coupled to the one or more memories, the one or more processors individually or collectively configured to:
receive a physical downlink (DL) control channel (PDCCH) transmission based at least in part on an uplink (UL) carrier aggregation that uses two or more DL-UL cells that share a same DL carrier, wherein the two or more DL-UL cells are based at least in part on a control channel element (CCE) index mapping; and
transmit, based at least in part on a scheduling and the UL carrier aggregation, an UL transmission via one of the two or more DL-UL cells.

2. The apparatus of claim 1, wherein the one or more processors are individually or collectively configured to:
receive a serving cell configuration information element (IE) that includes a configuration for the two or more DL-UL cells and UL control information, wherein the DL carrier is associated with a DL bandwidth part (DL-BWP) based at least in part on the configuration.

3. The apparatus of claim 1, wherein the one or more processors are individually or collectively configured to:
receive an indication of a scheduled DL-UL cell, of the two or more DL-UL cells, for an UL grant, wherein the UL transmission is based at least in part on the indication, and the scheduled DL-UL cell is associated with a cross-carrier scheduling or a self-carrier scheduling.

4. The apparatus of claim 3, wherein the indication is associated with a differentiation for determining the scheduled DL-UL cell, wherein the differentiation is based at least in part on a downlink control information (DCI) payload or payload size.

5. The apparatus of claim 1, wherein different CCE indexes are associated with different DL-UL cells in accordance with a mapping, the mapping is uniformly circular across the DL-UL cells or non-uniform across the DL-UL cells, and the mapping is static across slots or dynamic across slots.

6. The apparatus of claim 1, wherein PDCCH candidates from different DL-UL cells map to different CCE indexing patterns in a control resource set (CORESET).

7. The apparatus of claim 1, wherein non-contiguous CCE indexes map to the two or more DL-UL cells based at least in part on a CCE indexing pattern.

8. The apparatus of claim 1, wherein a non-contiguous starting CCE index for a PDCCH maps to the two or more DL-UL cells based at least in part on a CCE indexing pattern.

9. The apparatus of claim 1, wherein a non-contiguous starting CCE index and an ending CCE index for a PDCCH maps to the two or more DL-UL cells based at least in part on a CCE indexing pattern.

10. The apparatus of claim 1, wherein a puncturing of a number of CCEs in a mapped PDCCH candidate is based at least in part on a CCE indexing pattern, wherein the puncturing is based at least in part on a PDCCH candidate that cannot be mapped in a slot due to a collision with another PDCCH candidate.

11. The apparatus of claim 10, wherein the puncturing is based at least in part on a user equipment (UE) capability report that indicates that the UE is able to handle punctured PDCCH candidates, and a maximum number of PDCCH candidates is specified based at least in part on the UE capability report indicating that the UE is able to monitor PDCCH candidates with contiguously punctured CCEs, or the maximum number of PDCCH candidates is specified based at least in part on the UE capability report indicating that the UE is able to monitor PDCCH candidates with non-contiguously punctured CCEs.

12. The apparatus of claim 1, wherein contiguous CCE indexes map to the two or more DL-UL cells based at least in part on a CCE indexing pattern.

13. The apparatus of claim 1, wherein the one or more processors are individually or collectively configured to:
receive a configuration of a CCE indexes mapping to the two or more DL-UL cells, wherein CCE indexes are assigned to the two or more DL-UL cells in a dynamic manner.

14. The apparatus of claim 1, wherein the one or more processors are individually or collectively configured to:
receive an indication of cell ordering to indicate CCEs to be monitored, wherein the cell ordering is based at least in part on an absolute radio frequency channel number (ARFCN), or the cell ordering is based at least in part on a lowest frequency of a smallest resource block in an UL bandwidth part (BWP).

15. The apparatus of claim 1, wherein the one or more processors are individually or collectively configured to:
perform a cell selection based at least in part on a cell select parameter; or
perform a cell selection by measuring each DL-UL cell, of the two or more DL-UL cells, and connecting to a DL-UL cell of a highest quality of the two or more DL-UL cells.

16. The apparatus of claim 1, wherein a mapping of CCEs to PDCCH candidates scheduling a physical uplink shared channel (PUSCH) transmission in different DL-UL cells is based at least in part on an aggregation level.

17. The apparatus of claim 1, wherein the one or more processors are individually or collectively configured to:
receive a serving cell index parameter via radio resource control (RRC) signaling, wherein a CCE-to-PDCCH hashing function is based at least in part on the serving cell index parameter, wherein the CCE-to-PDCCH hashing function includes one or more values that are embedded with the serving cell index parameter, or the CCE-to-PDCCH hashing function is modified to incorporate the serving cell index parameter.

18. The apparatus of claim 17, wherein the CCE-to-PDCCH hashing function is modified with a cell-dependent offset and a mod operator to allow each DL-UL cell to observe a same control resource set (CORESET) and a shifted number of CCEs.

19. The apparatus of claim 1, wherein the one or more processors are individually or collectively configured to:
monitor a starting CCE type PDCCH candidate; or
monitor a starting CCE type and ending CCE type PDCCH candidate,
wherein a mapping order of starting CCEs to DL-UL cells is per user equipment (UE) based at least in part on a network scheduling a PDCCH in a shared control resource set (CORESET) with a defined number of CCEs.

20. The apparatus of claim 1, wherein:
different DL-UL cells serve different quality of service (QOS) requirements for different use cases and different aggregation levels (ALs) are assigned to the different DL-UL cells;
a radio network temporary identifier (RNTI) is configured to distinguish a particular DL-UL cell along a set of carrier aggregation configured DL-UL cells, wherein a slot number is useable as a differentiation factor for cell scheduling based at least in part on the RNTI; or
a user equipment (UE)-specific search space (USS) set numbering is useable as a differentiation factor for cell scheduling.

21. An apparatus of wireless communication, comprising:
one or more memories; and
one or more processors coupled to the one or more memories, the one or more processors individually or collectively configured to:
transmit a physical downlink (DL) control channel (PDCCH) transmission based at least in part on an uplink (UL) carrier aggregation that uses two or more DL-UL cells that share a same DL carrier, wherein the two or more DL-UL cells are based at least in part on a control channel element (CCE) index mapping; and
receive, based at least in part on a scheduling and the UL carrier aggregation, an UL transmission via one of the two or more DL-UL cells.

22. The apparatus of claim 21, wherein the one or more processors are individually or collectively configured to:
transmit a serving cell configuration information element (IE) that includes a configuration for the two or more DL-UL cells and UL control information, wherein the DL carrier is associated with a DL bandwidth part (DL-BWP) based at least in part on the configuration.

23. The apparatus of claim 21, wherein the one or more processors are individually or collectively configured to:
transmit an indication of a scheduled DL-UL cell, of the two or more DL-UL cells, for an UL grant, wherein the UL transmission is based at least in part on the indication, and the scheduled DL-UL cell is associated with a cross-carrier scheduling or a self-carrier scheduling.

24. The apparatus of claim 21, wherein different CCE indexes are associated with different DL-UL cells in accordance with a mapping, the mapping is uniformly circular across the DL-UL cells or non-uniform across the DL-UL cells, and the mapping is static across slots or dynamic across slots.

25. The apparatus of claim 23, wherein PDCCH candidates from different DL-UL cells map to different CCE indexing patterns in a control resource set (CORESET).

26. The apparatus of claim 21, wherein:
non-contiguous CCE indexes map to the two or more DL-UL cells based at least in part on a CCE indexing pattern;
a non-contiguous starting CCE index for a PDCCH maps to the two or more DL-UL cells based at least in part on a CCE indexing pattern;
a non-contiguous starting CCE index and an ending CCE index for a PDCCH maps to the two or more DL-UL cells based at least in part on a CCE indexing pattern;
a puncturing of a number of CCEs in a mapped PDCCH candidate is based at least in part on a CCE indexing pattern, wherein the puncturing is based at least in part on a PDCCH candidate that cannot be mapped in a slot due to a collision with another PDCCH candidate; or
contiguous CCE indexes map to the two or more DL-UL cells based at least in part on a CCE indexing pattern.

27. The apparatus of claim 21, wherein the one or more processors are individually or collectively configured to:
transmit a configuration of a CCE indexes mapping to the two or more DL-UL cells, wherein CCE indexes are assigned to the two or more DL-UL cells in a dynamic manner; or
transmit an indication of cell ordering to indicate CCEs to be monitored, wherein the cell ordering is based at least in part on an absolute radio frequency channel number (ARFCN), or the cell ordering is based at least in part on a lowest frequency of a smallest resource block in an UL bandwidth part (BWP).

28. The apparatus of claim 21, further comprising:
transmit a serving cell index parameter via radio resource control (RRC) signaling, wherein a CCE-to-PDCCH hashing function is based at least in part on the serving cell index parameter, wherein the CCE-to-PDCCH hashing function includes one or more values that are embedded with the serving cell index parameter, or the CCE-to-PDCCH hashing function is modified to incorporate the serving cell index parameter.

29. A method of wireless communication performed by a user equipment (UE), comprising:
receiving a physical downlink (DL) control channel (PDCCH) transmission based at least in part on an uplink (UL) carrier aggregation that uses two or more DL-UL cells that share a same DL carrier, wherein the two or more DL-UL cells are based at least in part on a control channel element (CCE) index mapping; and
transmitting, based at least in part on a scheduling and the UL carrier aggregation, an UL transmission via one of the two or more DL-UL cells.

30. A method of wireless communication performed by a network node, comprising:
transmitting a physical downlink (DL) control channel (PDCCH) transmission based at least in part on an uplink (UL) carrier aggregation that uses two or more DL-UL cells that share a same DL carrier, wherein the two or more DL-UL cells are based at least in part on a control channel element (CCE) index mapping; and
receiving, based at least in part on a scheduling and the UL carrier aggregation, an UL transmission via one of the two or more DL-UL cells.
